(19) United States
(12) Patent Application Publication
(10) Pub. No.: US 2023/0204982 A1
(43) Pub. Date: Jun. 29, 2023

(54) EYEWEAR WITH CHROMA ENHANCEMENT

(71) Applicant: Oakley, Inc., Foothill Ranch, CA (US)

(72) Inventor: Colin BOYLES, Fort Collins, CO (US)

(73) Assignee: Oakley, Inc., Foothill Ranch, CA (US)

(21) Appl. No.: 18/086,370

(22) Filed: Dec. 21, 2022

Related U.S. Application Data
(60) Provisional application No. 63/292,876, filed on Dec. 22, 2021.

(51) Int. Cl. G02C 7/10

(52) U.S. Cl. CPC G02C 7/104

(57) ABSTRACT

Embodiments comprise a lens for an eyewear. The lens includes an optical filter. A transmittance spectral profile of the optical filter includes a saddleback transmission valley having a local maximum transmittance, a first minimum transmittance, and a second minimum transmittance. The local maximum transmittance of the transmittance valley is positioned at a first wavelength from about 570 nm to about 600 nm. A difference in transmittance between the first minimum transmittance and the local maximum transmittance is less than 5%.

### CROSS-REFERENCE TO RELATED APPLICATIONS

The present application claims benefit of and priority to U.S. Provisional Patent App. No. 63/292,876, filed Dec. 22, 2021, which is incorporated herein by reference in its entirety for all purposes.

### BACKGROUND

Eyewear can include optical elements that attenuate light in one or more wavelength bands. For example, sunglasses typically include a lens that absorbs a significant portion of light in the visible spectrum. A sunglass lens can have a dark coating that strongly absorbs visible light, thereby significantly decreasing the luminous transmittance of the lens. Sunglass lenses, however, are not suitable for all purposes, such as, for example, for indoor use, driving, or select sporting activities.

### BRIEF DESCRIPTION OF THE DRAWINGS

Aspects of this disclosure are best understood from the following detailed description when read with the accompanying figures. It is noted that, in accordance with the common practice in the industry, various features are not drawn to scale. In fact, the dimensions of the various features may be arbitrarily increased or reduced for clarity of discussion.

FIG. 1 illustrates a perspective view of an eyewear configured to provide chroma enhancement, according to some embodiments.

FIGS. 2A-2C illustrate cross-sectional views of an optical filter configured to provide chroma enhancement for an eyewear, according to some embodiments.

FIGS. 3A -17B show optical characteristics of various optical filters of a lens, each optical filter configured to provide chroma enhancement, according to some embodiments.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. As used herein, the formation of a first feature on a second feature means the first feature is formed in direct contact with the second feature. In addition, the present disclosure may repeat reference numerals and/or letters in the various examples. This repetition does not in itself dictate a relationship between the various embodiments and/or configurations discussed.

Spatially relative terms, such as “beneath,” “underlying,” “underneath,” “below,” “lower,” “above,” “over,” “upper,” “lower,” and the like may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

It is noted that references in the specification to “one embodiment,” “an embodiment,” “an example embodiment,” “exemplary,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 5% of the value (e.g., ±1%, ±2%, ±3%, ±4%, or ±5% of the value).

As used herein, the term “between a first value and a second value,” as used for example in “a wavelength range is between 440 nm and 520 nm,” means that the wavelength range is from 440 nm to 520 nm, where end points of 440 nm and 520 nm are both included in the wavelength range.

As used herein, the term “visible spectral range” refers to a wavelength range from about 380 nm to about 780 nm.

As used herein, the term “across a spectral range” refers to all wavelengths (e.g., with an increment of 1 nm) within the spectral range, including the endpoints of the spectral range.

As used herein, the terms “over a spectral range” and “in a spectral range” refer to at least one wavelength within the spectral range.

As used herein, the term “optical transmittance” refers to the fraction of incident electromagnetic power transmitted through an object.

As used herein, the term “visible light transmittance (VLT)” refers to a luminous transmittance profile, such as using Commission Internationale de l'Elcairage (CIE) standard illuminant D65, ISO 12331, or ANSI Z80.3.

As used herein, the term “chroma enhancement filter” refers to a chroma enhancement material, a chroma enhancement dye, a chroma enhancement doping, a chroma enhancement coating, a chroma enhancement film, a chroma enhancement layer, a chroma enhancement wafer, or a chroma enhancement lens body that can provide chroma enhancement to increase the vividness of the perceived colors.

As used herein, the term “horizontal” refers to a direction along (i.e., in the plane) or substantially parallel to a surface of an eyewear's lens.

As used herein, the term “vertical” refers to a direction substantially perpendicular to the horizontal direction (i.e., perpendicular to the plane defined by an eyewear's lens's surface).

As used herein, the term “disposed,” as used for example in “a first layer is disposed over a second layer,” means that the first layer is either directly placed against the second layer's surface, or that the first layer is indirectly placed over the second layer's surface with at least a third layer in between.

As used herein, the term “coupled,” as used for example in “a first layer is coupled to a second layer” means that the first layer is disposed over the second layer (as “disposed” is defined above), or that the first layer is integrated into the second layer.

Objects that humans can visually observe in the environment typically emit, reflect, or transmit visible light from one or more surfaces. The surfaces can be considered an array of points that the human eye is unable to resolve any more finely. Each point on a surface typically does not emit, reflect, or transmit a single wavelength of light; rather, it emits, reflects, or transmits a broad spectrum of wavelengths that are interpreted as a single color in human vision. Generally speaking, if one were to observe the corresponding “single wavelength” of light for that interpreted color (for example, a visual stimulus having a very narrow spectral bandwidth, such as 1 nm), it would appear extremely vivid when compared to a color interpreted from a broad spectrum of observed wavelengths.

A lens for an eyewear can incorporate an optical filter to remove outer bands of a broad visual stimulus to make colors appear more vivid as perceived in human vision. Such eyewear can be configured to substantially increase the colorfulness, clarity, and/or vividness of a scene. Nevertheless, it may be challenging to balance a chroma enhancement (CE) ratio with passing driving standards due to the low optical transmission of the lens at certain wavelengths.

In some embodiments, the eyewear can include a lens that has a saddleback absorption profile in one or more spectral ranges. The lens may absorb light in a broader range in the one or more spectral ranges while having a minimum desired transmission at each wavelength in the spectral range. The saddleback absorption profile can be achieved using a combination of one or more dyes (e.g., one or more organic dyes). If only a single absorption dye at a given wavelength in the spectral range were to be used, the lens may absorb too much light at that singular wavelength and fail driving tests. Alternatively, if the lens includes a broadband dye for the spectral range, then the chroma enhancement benefits are minimized. Embodiments of the present disclosure effectively provide an eyewear having chroma enhancement while maintaining a desired transmission, thus suitable for use when driving. For example, embodiments of the present disclosure allow eyewear to provide chroma enhancement while also meeting ANSI Z80.3-2018, ISO 12312:2013, and AS/NZS 1067:2003-A2009 standards.

In some embodiments, the eyewear can include a lens that blocks one or more wavelengths in the blue spectrum while transmitting other wavelengths in the blue spectrum. For example, the lens may transmit blue wavelengths (e.g., about 445 nm to about 495 nm) that are beneficial during daylight hours (e.g., control daytime circadian cycle) while blocking undesired blue wavelengths (i.e., toxic blue, about 410 nm to 430 nm).

In some embodiments, the eyewear can include a lens that has chroma enhancement in one or more spectral windows. For example, the lens may have a saddleback absorption profile in one or more spectral ranges and a single absorption profile in one or more spectral ranges. In some embodiments, the lens can have an overall color appearance of grey/neutral.

The lens includes an optical filter having chroma enhancement. In some embodiments, the lens includes a lens body and a chroma enhancement filter. In some embodiments, the chroma enhancement filter can be bodily incorporated into the lens body. The chroma enhancement filter may be incorporated with other filters. In some embodiments, the lens can include an anti-reflection layer disposed over the lens body's rear surface. In some embodiments, the anti-reflection layer can be a coating or a film configured to reduce an optical reflectivity from the lens body's rear surface.

Embodiments of the present disclosure are directed to a lens for an eyewear that provides chroma enhancement in one or more wavelength bands, and a method of forming the same.

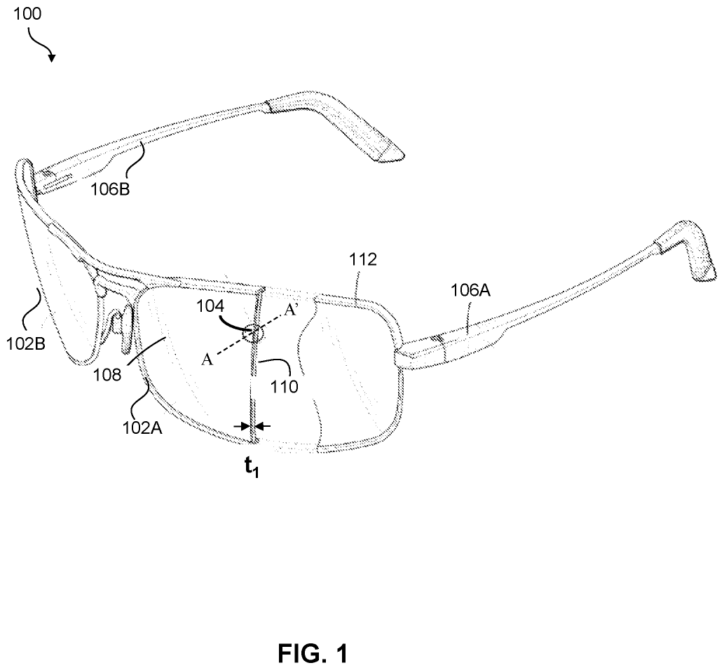

FIG. 1 illustrates a perspective view of an eyewear 100 configured to provide chroma enhancement, according to some embodiments. Eyewear 100 can include a lens 102A, a lens 102B, a mounting frame 112 configured to support the lenses 102A and 102B, and ear stems 106A and 106B attached to mounting frame 112. Eyewear 100 can be of any type, including general-purpose eyewear, special-purpose eyewear, sunglasses, driving glasses, sporting glasses, goggles, indoor eyewear, outdoor eyewear, eyewear incorporated into headgear (such as visors for helmets), vision-correcting eyewear, contrast-enhancing eyewear, chroma-enhancing eyewear, color-enhancing eyewear, color-altering eyewear, gaming eyewear, eyewear designed for another purpose, or eyewear designed for a combination of purposes. In some embodiments, lenses and frames of many other shapes and configurations may be used for eyewear 100. For example, eyewear 100 can have a single lens, such as in a goggle or visor. It should be noted that eyewear 100 shown in FIG. 1 is not drawn to scale but is drawn to more easily illustrate certain aspects of eyewear 100.

Lenses 102A and 102B have an optical filter that provides chroma enhancement while transmitting a desired amount of light to pass driving tests. In some embodiments, the optical filter provides chroma enhancement in a range from about 570 nm to about 600 nm. Lenses 102A and 102B can be non-corrective or corrective for vision. In some embodiments, lenses 102A and 102B can be configured to provide vision correction for a wearer of eyewear 100, and can have optical power. Such lenses can be configured to correct for near-sighted or far-sighted vision or astigmatism. In other embodiments, lenses 102A and 102B are non-corrective or plano lenses that lack such optical power for vision correction.

Lenses 102A and 102B can include an optical filter 104. Each lens 102A and 102B has a front surface 108 and a rear surface 110. In some embodiments, front surface 108 and/or rear surface 110 can be a hydrophobic surface. Optical filter 104 can be configured to provide any desired lens chromaticity, a chroma-enhancing effect, a photochromic effect, an electrochromic effect, an optical polarizing effect, or any combination thereof. In some embodiments, lenses 102A and 102B can be configured to provide a substantially neutral visible light spectral profile as seen through lenses 102A and 102B. For example, an overall color appearance of lenses 102A and 102B can be substantially color neutral and substantially transparent. In some embodiments, an overall color appearance of lenses 102A and 102B can be substantially gray. In some embodiments, the overall color appearance of lenses 102A and 102B has a yellowness index YI E313 less than about 20, less than about 15, less than about 10, less than about 5, less than about 1, or from about 40 to about 45.

Lenses 102A and 102B can be made of any of a variety of optical materials including glasses or plastics such as acrylics or polycarbonates. The lenses can have various shapes. For example, each of lenses 102A and 102B can be flat, have one axis of curvature, two axes of curvature, or more than two axes of curvature. Each of lenses 102A and 102B can be cylindrical, parabolic, spherical, toroidal, flat, or elliptical, or any other shape such as a meniscus or catenoid. In some embodiments, each of lenses 102A and 102B can have a blank diameter ranging from about 75 mm to about 90 mm. When worn, lenses 102A and 102B can extend across the wearer's normal straight ahead line of sight, and can extend substantially across the wearer's peripheral zones of vision. As used herein, the wearer's normal line of sight shall refer to a line projecting straight ahead of the wearer's eye, with substantially no angular deviation in either the vertical or horizontal planes. In some embodiments, lenses 102A and 102B can extend across a portion of the wearer's normal straight ahead line of sight. Providing curvature in the lenses 102A and 102B can result in various advantageous optical qualities for the wearer, including reducing the prismatic shift of light rays passing through the lenses 102A and 102B, and providing an optical correction, such as correcting an optical distortion or modifying an optical focal power. Regardless of the particular vertical or horizontal curvature of front surface 108 and rear surface 110 of each of lens 102A and 102B, however, other types of front surface 108 and rear surface 110 of each of lens 102A and 102B may be chosen such as to minimize one or more of power, prism, and astigmatism of lens 102A and 102B in the mounted and as-worn orientation. In some embodiments, each of lenses 102A and 102B can be a plano lens configured to provide the optical correction. In some embodiments, lenses 102A and 102B can be a lens blank or semi-finished so that lenses 102A and 102B can be capable of being machined, at some time following manufacture, to provide the optical correction for the wearer. In some embodiments, lenses 102A and 102B can have optical power and can be prescription lenses configured to correct for near-sighted or far-sighted vision. In some embodiments, lenses 102A and 102B can have cylindrical characteristics to correct for astigmatism. In some embodiments, lenses 102A and 102B can be canted and mounted in a position rotated laterally relative to centrally oriented dual lens mountings.

Each of lenses 102A and 102B can have a thickness ti between front surface 108 and rear surface 110. In some embodiments, thickness ti can be varied along front surface 108 and/or rear surface 110. For example, thickness ti can be varied along a horizontal direction between ear stems 106A and 106B. Thickness ti can also be varied along a vertical direction perpendicular to the horizontal direction and along front surface 108/rear surface 110. In some embodiments, thickness ti can be a tapering thickness along a horizontal axis and can be decentered for the optical correction. In some embodiments, thickness ti can be configured to provide the optical correction for lenses 102A and 102B.

Mounting frame 112 can include orbitals that partially or completely surround the lenses 102A and 102B. Mounting frame 112 can be made of a variety of suitable materials including, for example and without limitation, metal, acetate, nylon, etc. Mounting frame 112 can be of varying configurations and designs, and the illustrated embodiment shown in FIG. 1 is provided for exemplary purposes only. As illustrated, mounting frame 112 can include a top frame portion and a pair of ear stems 106A and 106B connected to opposing ends of the top frame portion. Ear stems 106A and 106B can be configured to support the eyewear 100 when worn by a user. In some embodiments, eyewear 100 can include a flexible band (not shown in FIG. 1) used to secure eyewear 100 in front of the wearer's eyes in place of ear stems 106A and 106B. Further, lenses 102A and 102B may be mounted to the frame 112 with an upper edge of lens 102A and/or 102B extending along or within a lens groove and being secured to mounting frame 104. For example, the upper edge of lens 102A and/or or 102B can be formed in a pattern, such as a jagged or non-linear edge, and apertures or other shapes around which mounting frame 104 can be injection molded or fastened to secure lens 102A and/or 102B. Further, lenses 102A and 102B can be attachable to mounting frame 104 by means of a slot with inter-fitting projections or other attachment structure formed in lenses 102A and 102B and/or mounting frame 104. It is also contemplated that lenses 102A and 102B can be secured along a lower edge of mounting frame 112. Various other configurations can also be utilized. Such configurations can include direct attachments of ear stems 106A and 106B or a strap to lenses 102A and 102B without any frame, or other configurations that can reduce the overall weight, size, or profile of the eyeglasses. In some embodiments, mounting frame 112 can be configured to retain a unitary lens placed in front of both of the wearer's eyes. In some embodiments, the lens may be a standalone unitary lens that directly attach to ear stems 106A and 106B or to a strap.

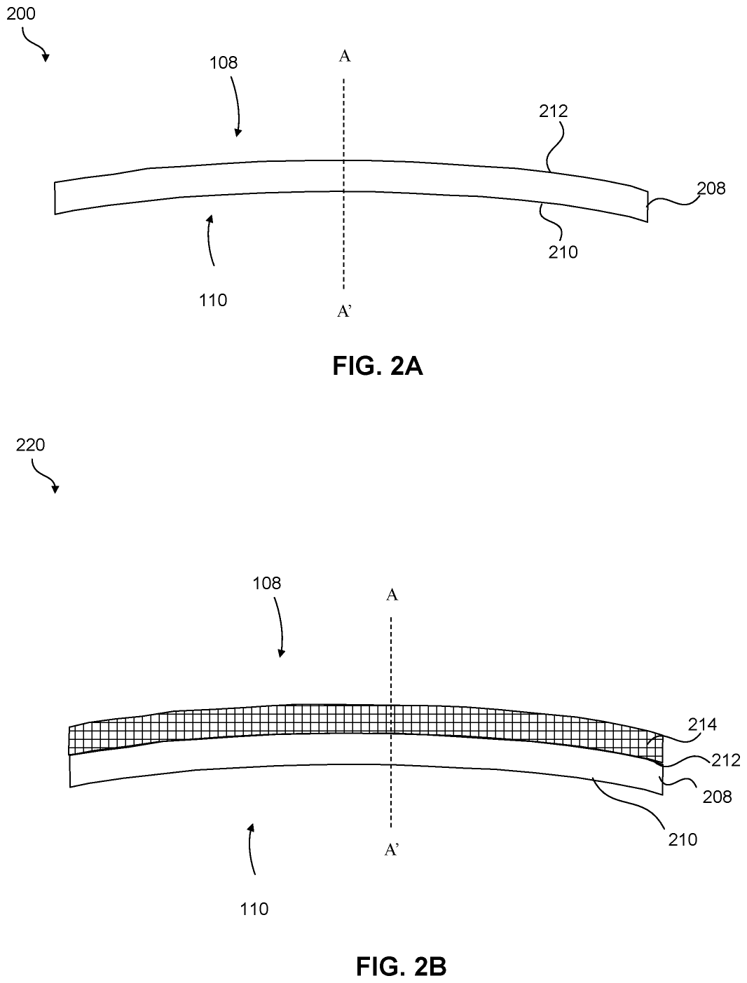

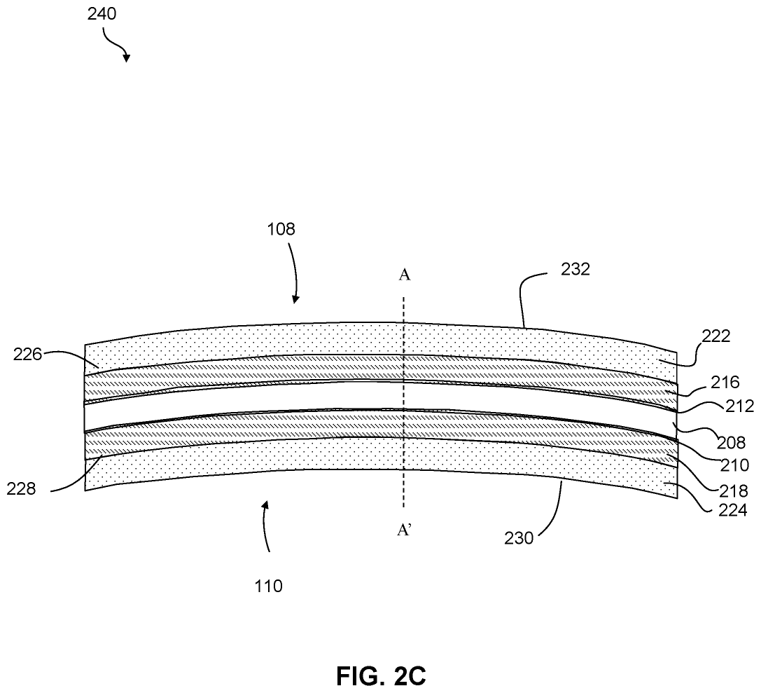

FIG. 2A shows a cross-sectional view of a lens 200, according to some embodiments. Lens 200 can be an embodiment of lenses 102A and 102B shown in FIG. 1. The discussion of lenses 102A and 102B applies to lens 200, unless mentioned otherwise. Further, the discussion of elements with the same annotations in FIGS. 1 and 2A applies to each other, unless mentioned otherwise. Section line A-A′ is shown in both FIG. 1 and FIG. 2A to illustrate the relative orientation of lens 200 between the two figures. As shown in FIG. 2A, lens 200 can have front surface 108 and rear surface 110, can include a lens body 208 having a front surface 212 and a rear surface 210. In some embodiments, front surface 212 and rear surface 210 can respectively represent lens 200's front surface and rear surface.

Lens body 208 can include optical filter 104. For example, optical filter 104 can be integrated with lens body 208. Optical filter 104 can be configured to filter undesired wavelengths. In some embodiments, optical filter 104 can minimize optical transmittance in a range from about 410 nm to about 430 nm. In some embodiments, optical filter 104 can provide CE in a range from about 550 nm to about 630 nm.

Lens body 208 can be formed of polycarbonate (PC), allyl diglycol carbonate monomer (being sold under the brand name CR-39®), a resin layer (e.g., MR-8®), glass, nylon, polyurethane, polyethylene, polyamide (PA), polyethylene terephthalate (PET), biaxially-oriented polyethylene terephthalate polyester film (BoPET, with one such polyester film sold under the brand name MYLAR®), acrylic (polymethyl methacrylate or PMMA), triacetate cellulose (TAC), a polymeric material, a co-polymer, a doped material, any other suitable material, or any combination of materials. In some embodiments, lens body 208 can be an injection molded, polymeric lens body.

Lens body 208 can have a concave surface and a convex surface. Lens body 208 can have a desired base curve and thickness (e.g., thickness ti shown in FIG. 1) to provide the optical correction. For example, each of lens body 208's front surface 212 and rear surface 210 can have a spheric, toric, cylindrical, or freeform geometry with proper thickness distribution (e.g., tapering thickness along front surface 212 and/or rear surface 210). Front surface 212 and/or rear surface 210 can have spheric, toric, or cylindrical geometries with a non-zero base curve in a horizontal and/or vertical direction. In some embodiments, front surface 212 and/or rear surface 210 can have spheric, toric, or cylindrical geometries with a base curve of about base 4 and greater, about base 6 and greater, or about base 8 and greater.

In some embodiments, lens body 208 can further integrate with one or more chroma enhancement filters configured to increase a scene's vividness viewed through eyewear 100 while maintaining a minimal desired transmittance to pass driving tests. For example, the chroma enhancement filters can be dispersed throughout lens body 208. In some embodiments, the chroma enhancement filter can be at least partially incorporated into lens body 208. In some embodiments, lens body 208 can be impregnated with, loaded with, or otherwise include the chroma enhancement filters. The vividness of interpreted colors can be correlated with an attribute known as a chroma value of a color. The chroma value can be one of the attributes or coordinates of the CIE L*C*h* color space. Together with attributes known as hue and lightness, the chroma value can be used to define colors perceivable in human vision. It has been determined that visual acuity can be positively correlated with the chroma values of colors in an image. In other words, the visual acuity of an observer can be greater when viewing a scene with high chroma value colors than when viewing the same scene with lower chroma value colors. Therefore, lens body 208 can be configured to enhance the chroma profile of a scene viewed through lens 200. In some embodiments, lens body 208 having chroma enhancement properties can be a molded body. In some embodiments, the chroma enhancement filter can be provided as a layer enclosed by or intermixed with lens body 208. In some embodiments, lens body 208 having chroma enhancement properties can be configured to increase or decrease the chroma value in one or more chroma enhancement windows in the visible spectral range. The chroma enhancement filter(s) integrated with lens body 208 can be further configured to preferentially transmit or attenuate light in the one or more chroma enhancement windows to provide enhanced chroma values. For example, an environment can predominantly reflect or emit a color, where the chroma enhancement filter integrated with lens body 208 can be adapted to provide the chroma enhancement by attenuating or enhancing an optical transmittance for one or more wavelengths associated with the predominantly reflected or emitted color.

In some embodiments, the chroma enhancement filter is integrated with lens body 208, and can include one or more dyes. In some embodiments, the dyes are organic dyes. In some embodiments, the dyes include one or more of an Exciton ABS 473, ABS 574, or ABS 594 dye.

In some embodiments, lens 200 can further include one or more functional layers (not shown in FIG. 2A), such as an optical filter configured to provide optical filtering, a polarizer configured to provide polarization, an electro-chromic layer configured to provide electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 200, or to improve bonding or adhesion among the layers in lens 200, a physical vapor deposition (PVD) layer, or any combination of these. In some embodiments, the chroma enhancement filter can be at least partially incorporated into the one or more functional layers in lens 200. In some embodiments, the one or more functional layers in lens 200 can be impregnated with, loaded with, or otherwise include the chroma enhancement filters.

In some embodiments, the lens can include an ultraviolet (UV) absorption layer in the optical filter or a layer that includes UV absorption outside of the optical filter layer. Such a layer can decrease bleaching of the optical filter. In addition, UV absorbing agents can be disposed in any lens component or combination of lens components (e.g., optical filter 104). In some embodiments, the lens may have an UV transmission cutoff at a wavelength from about 380 nm to about 400 nm. In some embodiments, the transmission below about 400 nm, below about 390 nm, or below about 380 nm is less than about 10%, less than about 5%, or less than about 1%. In some embodiments, the lens has a sharp spectral cutoff at about 390 nm or at about 400 nm.

In some embodiments, a transmittance spectral profile of the lens 200 comprises a saddleback transmission valley. The saddleback transmission valley has a first minimum transmittance, a local maximum transmittance, and a second minimum transmittance. The local maximum transmittance of the transmittance valley is positioned at a wavelength from about 570 nm to about 600 nm, from about 575 nm to about 595 nm, from about 580 nm to about 590 nm, at about 584 nm, at about 585 nm, or at about 586 nm. A difference in transmittance between the first minimum transmittance and the local maximum transmittance is less than about 15%, less than about 10%, less than about 5%, less than about 4%, or less than about 3%. In some embodiments, a difference in transmittance between the second minimum transmittance and the local maximum transmittance is less than about 15%, less than about 10%, or less than about 5%. In some embodiments, transmittance at each of the first minimum transmittance and the second minimum transmittance is greater than about 5%, greater than about 5% and less than about 20%, greater than about 5% and less than about 10%. In some embodiments, the local maximum transmittance is from about 5% to about 20%, 5% to about 10%, or about 10% to about 20%.

In some embodiments, the saddleback transmittance valley is a transmittance valley between a first transmittance peak and a second transmittance peak. The first transmittance peak may be positioned at a wavelength from about 520 nm to about 560 nm, and the second transmittance peak positioned at a wavelength from about 610 nm to about 650 nm. Transmittance of the first transmittance peak is from about 10% to about 40%, about 10% to about 20%, or about 30% to about 40%. Transmittance of the second transmittance peak is from about 20% to about 50%, about 20% to about 30%, about 40% to about 50%.

In some embodiments, the saddleback transmittance valley can be between a lower edge portion and an upper edge portion. A difference in transmittance between a transmittance at the lower edge portion and the minimum transmittance is less than about 25%. A transmittance at the upper edge portion and the minimum transmittance is less than about 40%.

Each transmittance valley can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. For example, if the minimum transmittance is 20%, the bandwidth of the minimum transmittance plus 10% would be measured as corresponding to 30% transmittance. A spectral bandwidth of the saddleback transmittance valley at the local minimum transmittance plus 10% is less than or equal to about 40 nm. In some embodiments, a spectral bandwidth of the saddleback transmittance valley at the local minimum transmittance plus 25% of the local minimum transmittance is less than or equal to about 40 nm. In some embodiments, the spectral bandwidth at the minimum transmittance plus 20% is greater than or equal to about 40 nm.

In some embodiments, an absorbance spectral profile of the lens 200, indicating an optical density of the lens at specific wavelengths, comprises a saddleback absorbance peak. The saddleback absorbance peak may have a local minimum absorbance located between a first maximum absorbance and a second maximum absorbance. In some embodiments, an optical density at the first maximum absorbance of the saddleback peak is from about 0.5 to about 1.5, about 0.5 to about 1, or about 1 to about 1.5. In some embodiments, the local minimum absorbance is positioned at a wavelength from about 570 nm to about 600 nm, from about 575 nm to about 595 nm, from about 580 nm to about 590 nm, about 584 nm, about 585 nm, or about 586 nm.

In some embodiments, the saddleback absorbance peak is an absorbance peak between a first absorbance minimum and a second absorbance minimum. The first absorbance minimum is positioned at a wavelength from about 520 nm to about 560 nm or from about 520 nm to about 540 nm. The second absorbance minimum is positioned at a wavelength from about 610 nm to about 650 nm or from about 620 nm to about 640 nm.

In some embodiments, the transmittance spectral profile of lens 200 includes a transmittance valley. The transmittance valley has a minimum transmittance positioned at a wavelength from about 465 nm to about 505 nm, from about 470 nm to about 480 nm, from about 485 nm to about 505 nm, about 476 nm, about 477 nm, about 478 nm, about 499 nm, about 500 nm, or about 501 nm. The minimum transmittance of the transmittance valley is less than about 25%. In some embodiments, the transmittance valley may be a saddleback transmittance valley.

In some embodiments, an absorbance spectral profile of the lens 200 comprises an absorbance peak. The absorbance peak may have a maximum absorbance positioned at a wavelength from about 465 nm to about 505 nm, from about 470 nm to about 480 nm, from about 485 nm to about 505 nm, at about 476 nm, at about 477 nm, at about 478 nm, at about 499 nm, at about 500 nm, or at about 501 nm.

In some embodiments, an average transmittance of the lens 200 in a spectral range of about 480 nm to about 530 nm is greater than about 5%, greater than about 6%, greater than about 7%, greater than about 8%, greater than about 10%, greater than about 15%, or greater than about 25%.

In some embodiments, a visible light transmission (as defined by EN1836) is from about 10% to about 50%, from about 10% to about 45%, from about 10% to about 40%, from about 10% to about 30%, from about 10% to about 20%, from about 15% to about 35%, from about 15% to about 25%, from about 15% to about 20%, from about 10% to about 15%, from about 20% to about 40%, from about 25% to about 35%, or from about 30% to about 35%.

In some embodiments, a CIE chromaticity x value of lens 200 is from about 0.45 to about 0.85, from about 0.50 to about 0.8, from about 0.55 to about 0.75, from about 0.60 to about 0.7, from about 0.45 to about 0.5, from about 0.5 to about 0.55, from about 0.55 to about 0.6, from about 0.6 to about 0.65, from about 0.65 to about 0.75, from about 0.75 to about 0.8, or from about 0.8 to about 0.85.

In some embodiments, a CIE chromaticity y value of lens 200 is from about 0.45 to about 0.85, from about 0.50 to about 0.8, from about 0.55 to about 0.75, from about 0.60 to about 0.7, from about 0.45 to about 0.5, from about 0.5 to about 0.55, from about 0.55 to about 0.6, from about 0.6 to about 0.65, from about 0.65 to about 0.75, from about 0.75 to about 0.8, or from about 0.8 to about 0.85.

In some embodiments, a scotopic transmission of the lens 200 is less than or equal to about 45%, less than equal to about 40%, less than or equal to about 35%, less than or equal to about 30%, less than or equal to about 25%, less than or equal to about 20%, less than or equal to about 15%, or less than or equal to about 10%.

FIG. 2B shows a cross-sectional view of lens 220, according to some embodiments. Lens 220 can be an embodiment of lenses 102A and 102B (shown in FIG. 1) or lens 200 (shown in FIG. 2A). The discussion of lenses 102A and 102 B, and lens 200 applies to lens 220, unless mentioned otherwise. Further, the discussion of elements with the same annotations in FIGS. 1, 2A and 2B applies to each other, unless mentioned otherwise. As shown in FIG. 2B, lens 220 can have front surface 108 and rear surface 110, lens body 208, and a chroma enhancement layer 214 coupled to lens body 208.

Chroma enhancement layer 214 can be placed over lens body 208's front surface 212 and/or lens body 208's rear surface 210. Chroma enhancement layer 214 may be an embodiment of optical filter 104. In some embodiments, chroma enhancement layer 214 can physically contact lens body 208. Chroma enhancement layer 214 can be configured to provide the chroma enhancement for lens 220. Chroma enhancement layer 214 can be further configured to preferentially transmit or attenuate light in the one or more chroma enhancement windows to provide enhanced chroma values. For example, an environment can predominantly reflect or emit a color, where chroma enhancement layer 214 can be adapted to attenuate or enhance an optical transmittance for one or more wavelengths associated with the predominantly reflected or emitted color. In some embodiments, optical filter 104 may also be at least partially incorporated in lens body 208.

In some embodiments, lens 220 can further include one or more functional layers (not shown in FIG. 2B), such as an optical filter configured to provide an optical filtering, a polarizer configured to provide a polarization, an electro-chromic layer configured to provide an electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 220, or to improve bonding or adhesion among the layers in lens 220, a physical vapor deposition (PVD) layer, or any combination of these. In some embodiments, the chroma enhancement filter 214 can be at least partially incorporated into the one or more functional layers in lens 220. In some embodiments, the one or more functional layers in lens 220 can be impregnated with, loaded with, or otherwise include the chroma enhancement filters.

FIG. 2C shows a cross-sectional view of lens 240, according to some embodiments. Lens 240 can be an embodiment of lenses 102A and 102B shown in FIG. 1, lens 220 shown in FIG. 2A, or lens 220 shown in FIG. 2B. The discussion of lenses 102A, 102B, 200, and 220 applies to lens 240, unless mentioned otherwise. Further, the discussion of elements with the same annotations in FIGS. 1, 2A, 2B, and 2C applies to each other, unless mentioned otherwise.

As shown in FIG. 2C, lens 240 can include lens body 208, a hard coat layer 216 disposed over lens body 208's front surface 212, and a hard coat layer 218 disposed over lens body 208's rear surface 210. Further, lens 240 can also include an anti-reflection layer 222. In some embodiments, lens 240 can also include a second anti-reflection layer 224.

In some embodiments, optical filter 104 may be incorporated or partially incorporated in one or more of the lens body 208, the hard coat layer 216, or the hard coat layer 218. In addition or alternatively, optical filter 104 may be incorporated in one or more chroma enhancement layers such as chroma enhancement layer 214 not shown in FIG. 2C.

In some embodiments, hard coat layers 216 and 218 can include a polymeric material configured to increase an abrasion resistance, a mechanical durability, and/or chemical resistance of lens 240. Hard coat layer 216 can be disposed over lens body 208's front surface 212, and can have a surface 226 facing outwards (e.g., away from eyewear 100's wearer). Hard coat layer 218 can be disposed over lens body 208's rear surface 210, and can have a surface 228 facing inwards (e.g., towards eyewear 100's wearer). In some embodiments, hard coat layer 216 and/or hard coat layer 218 can be impregnated with, loaded with, or otherwise include chroma enhancement filters.

As a result, hard coat layers 216 and 218 can protect lens body 208 from being damaged (e.g., scratched), thus avoiding degrading lenses 102A and 102B. In some embodiments, hard coat layers 216 and 218 can have substantially identical material and/or thickness to each other.

Anti-reflection layer 222 can be disposed over lens 240's front surface 108 and can be configured to reduce an optical reflectivity from front surface 110 across or over the visible spectral range. As shown in FIG. 2C, anti-reflection layer 222 can be disposed over hard coat layer 216's outward surface 226. In some embodiments, anti-reflection layer 222 can have an exposed surface 232 representing lens 240's front surface 108. In some embodiments, an optical reflectivity from anti-reflection layer 224's surface 230 can be less than about 80%, less than about 60%, less than about 40%, less than about 20%, less than about 15%, less than about 10%, or less than about 5% across or over the visible spectral range.

Anti-reflection layer 224 can be disposed over lens 240's rear surface 110, and can be configured to reduce an optical reflectivity from rear surface 110 across or over the visible spectral range. As shown in FIG. 2C, anti-reflection layer 224 can be disposed over hard coat layer 218's inward surface 228. In some embodiments, anti-reflection layer 224 can have an exposed surface 230 representing lens 240's rear surface 110. In some embodiments, an optical reflectivity from anti-reflection layer 224's surface 230 can be less than about 80%, less than about 60%, less than about 40%, less than about 20%, less than about 15%, less than about 10%, or less than about 5% across or over the visible spectral range.

In some embodiments, lens 240 can further include one or more functional layers (not shown in FIG. 2C), such as an optical filter configured to provide optical filtering, a polarizer configured to provide polarization, an electro-chromic layer configured to provide electrochromism, a reflection layer configured to provide a partial reflection of incoming visible light, an absorption layer configured to provide a partial or complete absorption of infrared light, a color enhancement layer, a color alteration layer, an anti-static functional layer, an anti-fog functional layer, a scratch resistance layer, a mechanical durability layer, a hydrophobic functional layer, a reflective functional layer, a darkening functional layer, an aesthetic functional layer including tinting, a glue layer, a mechanical protection layer configured to provide mechanical protection to lenses 102A and 102B, to reduce stresses within lens 240, or to improve bonding or adhesion among the layers in lens 240, a physical vapor deposition (PVD) layer, or any combination of these.

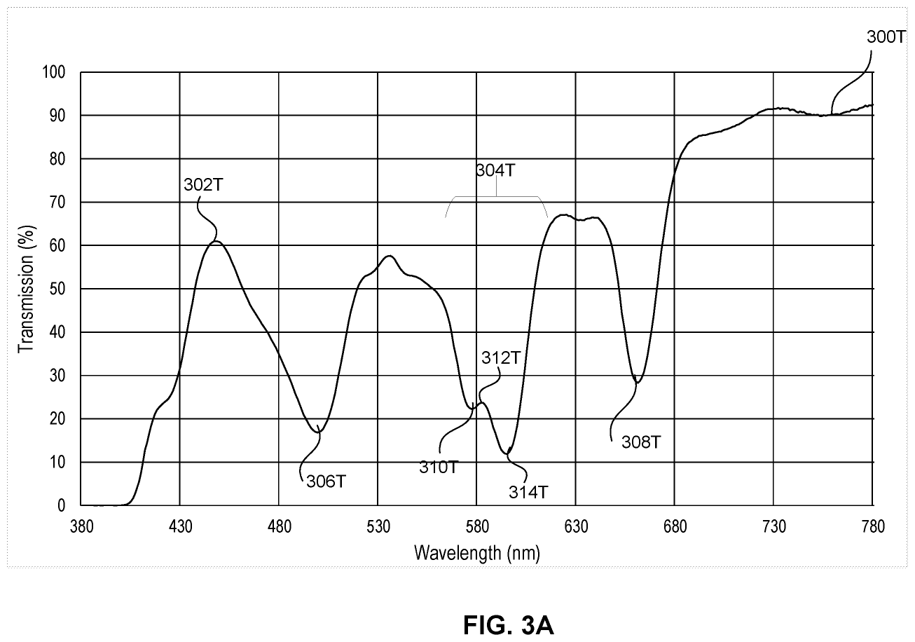

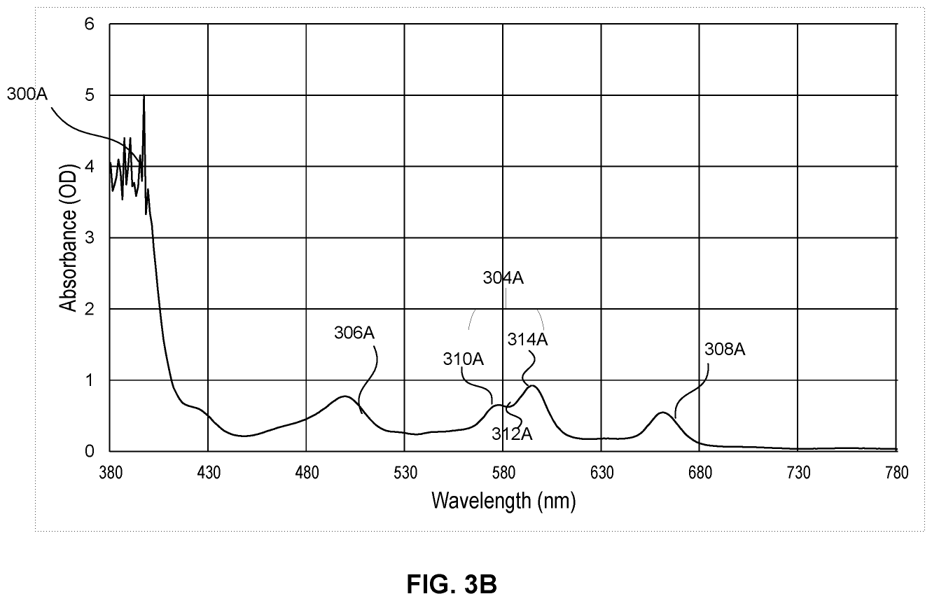

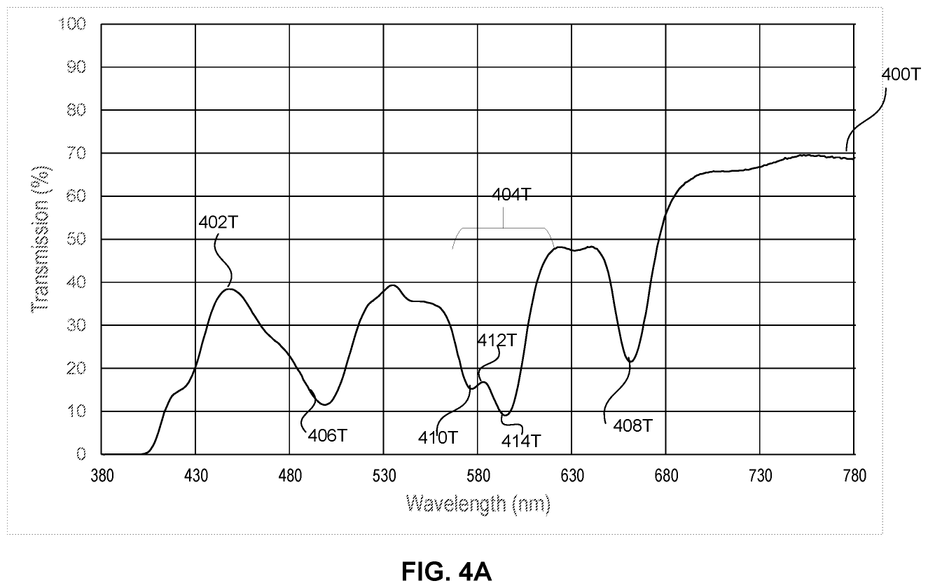

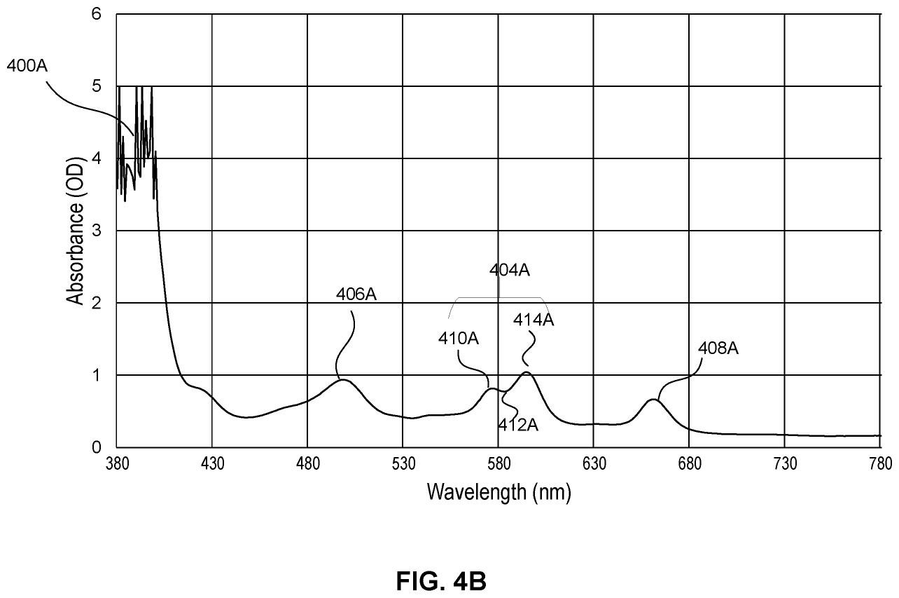

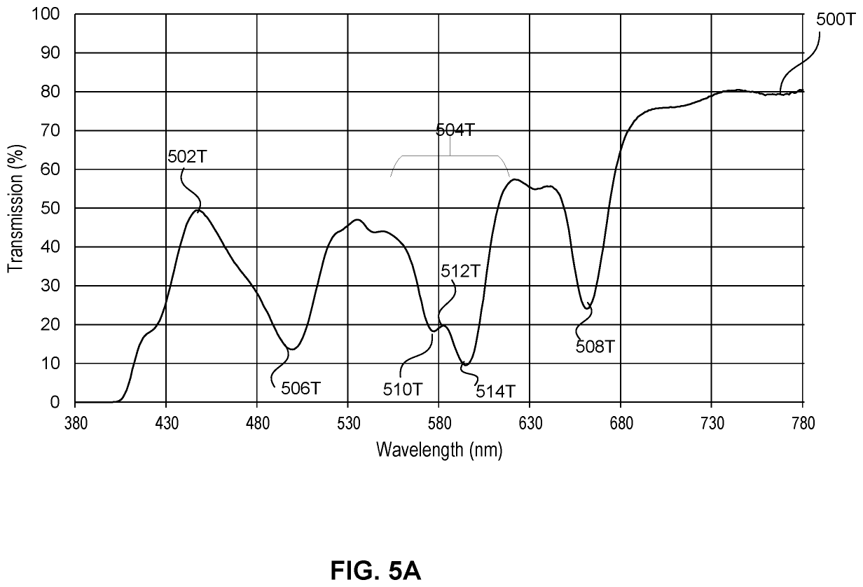

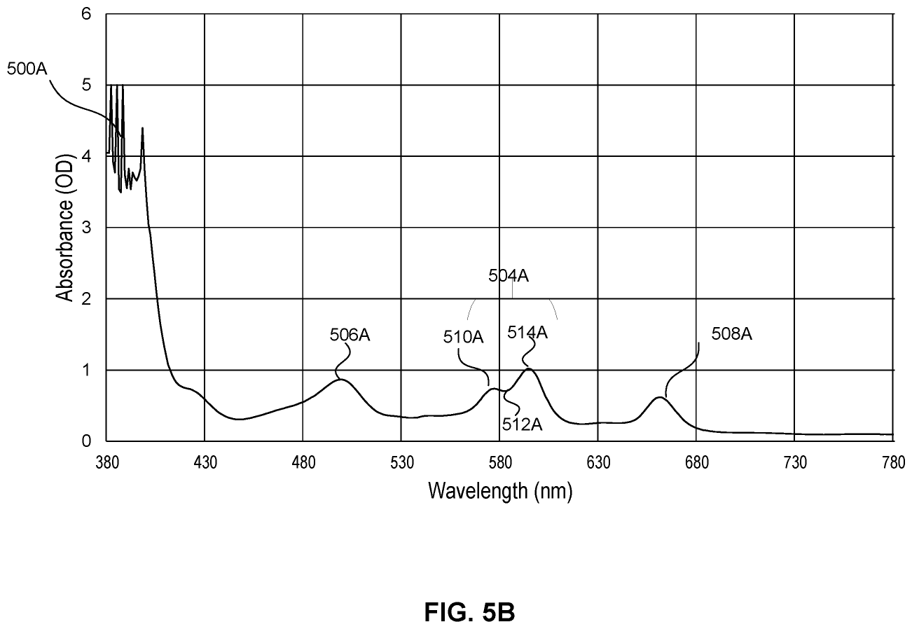

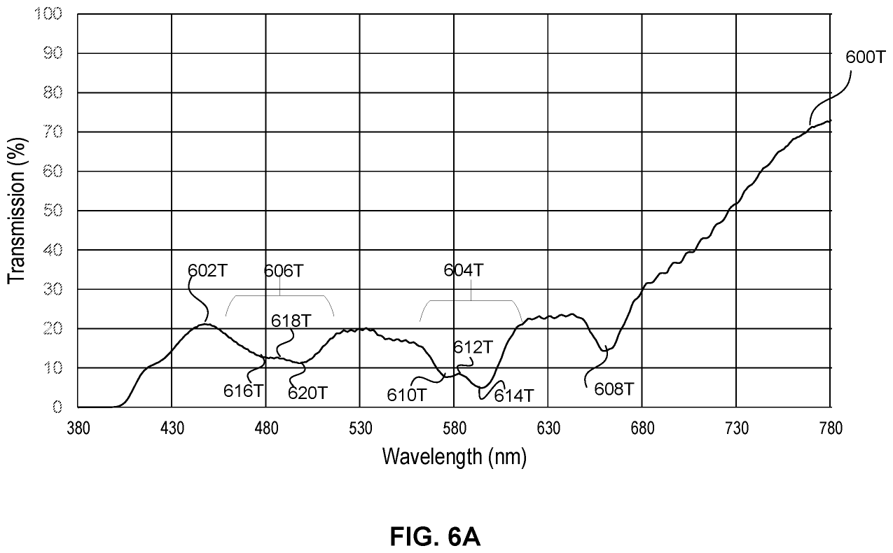

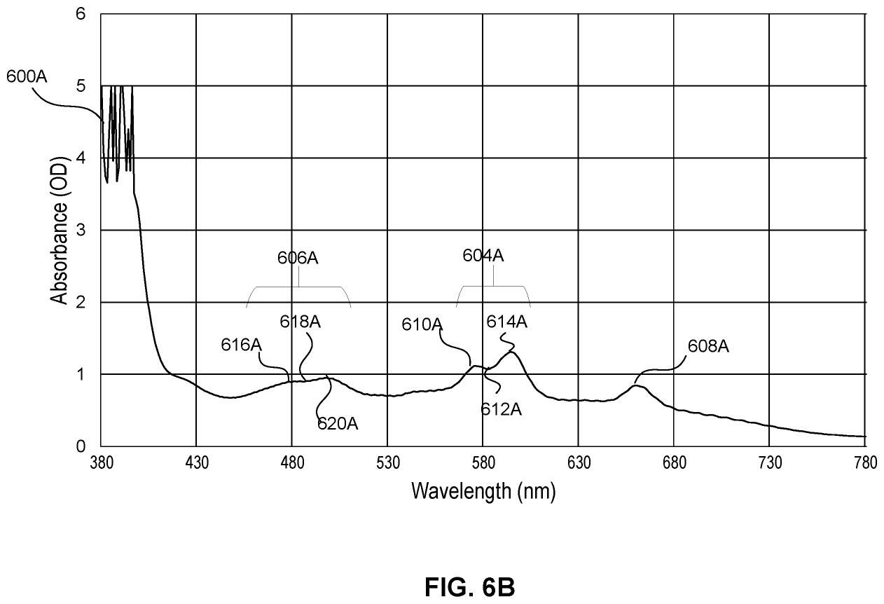

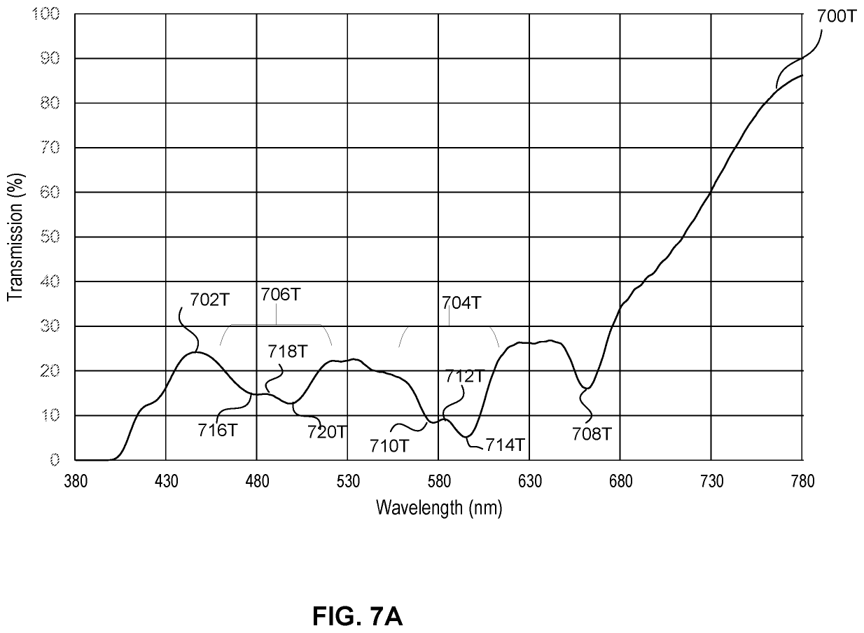

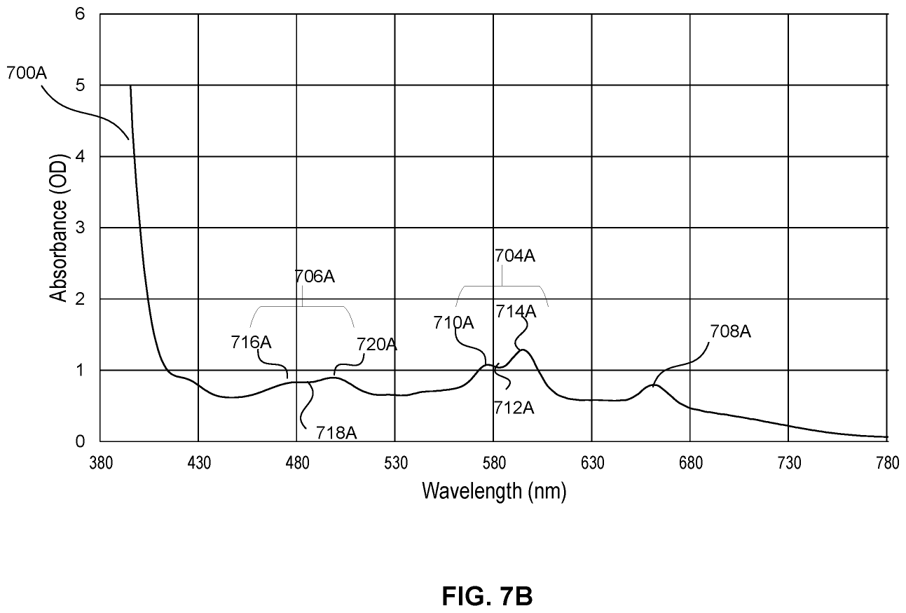

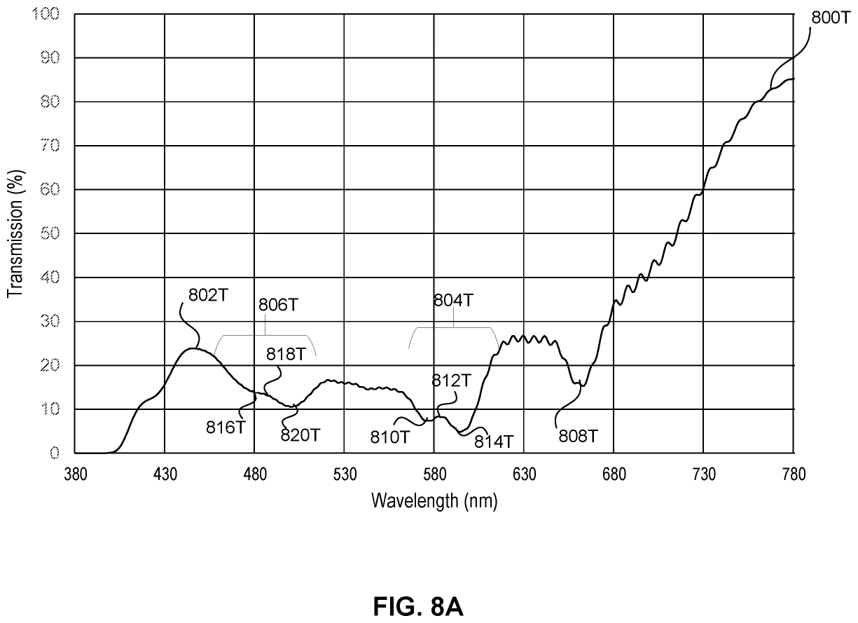

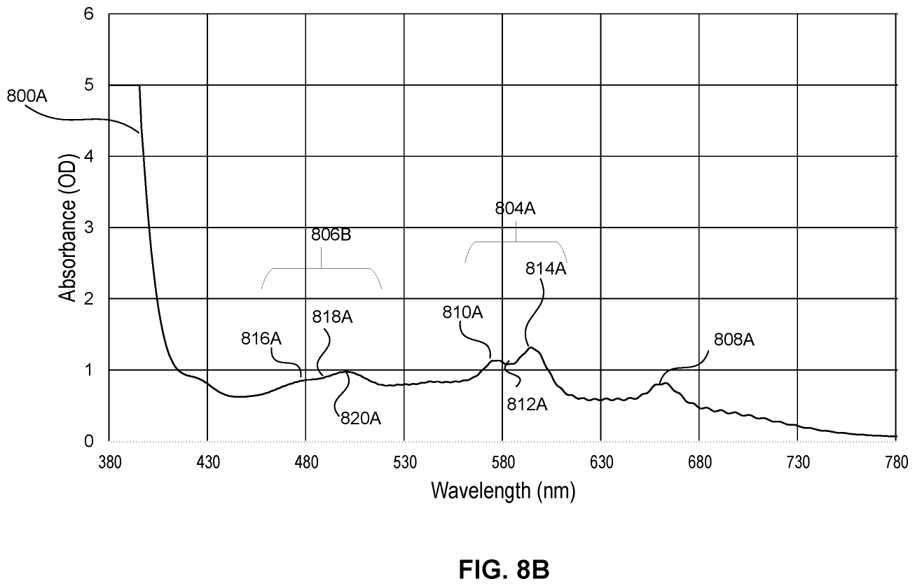

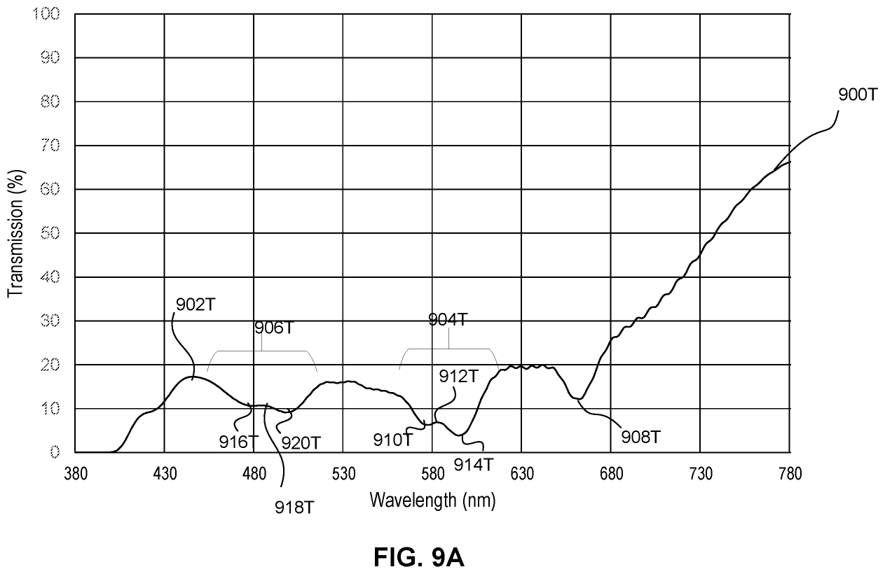

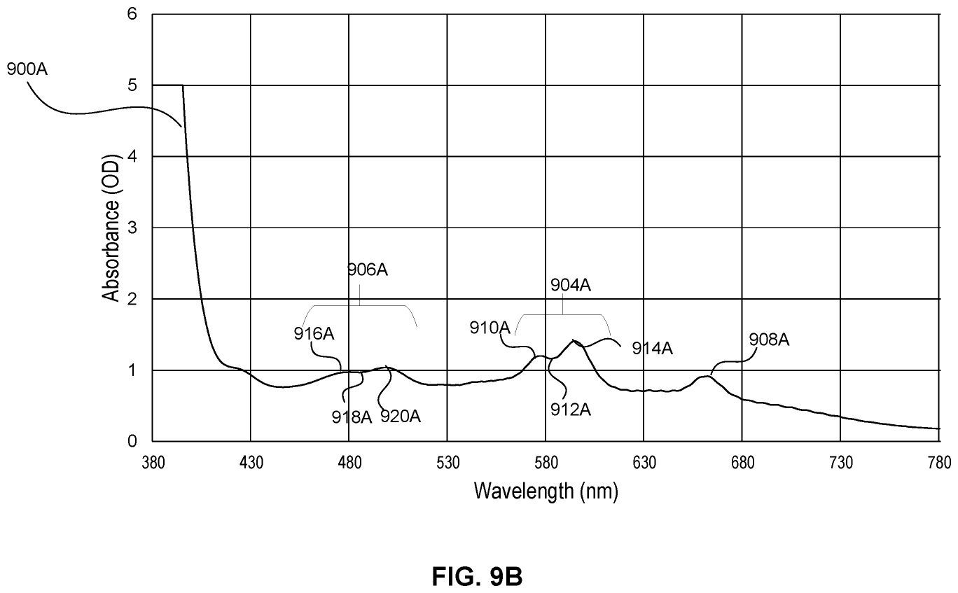

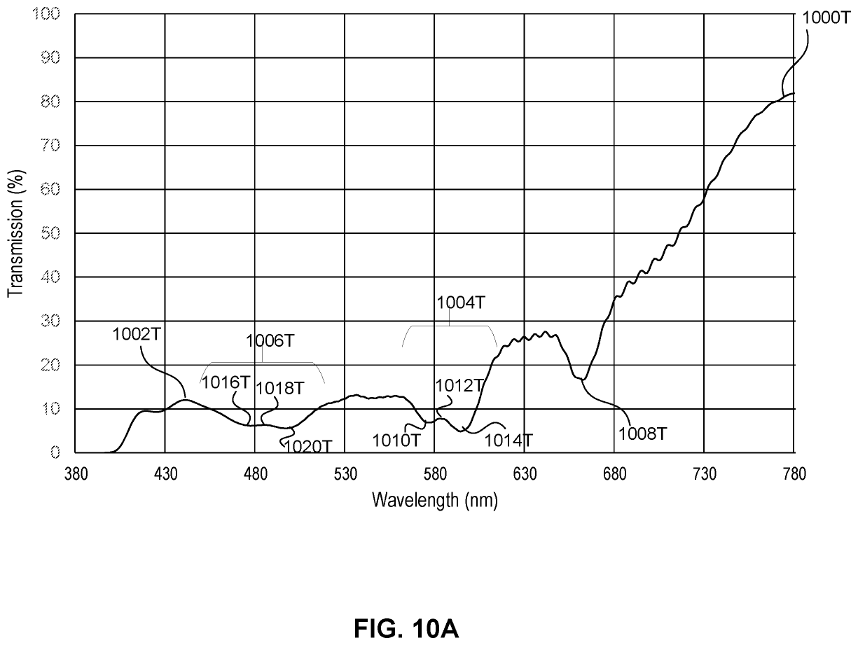

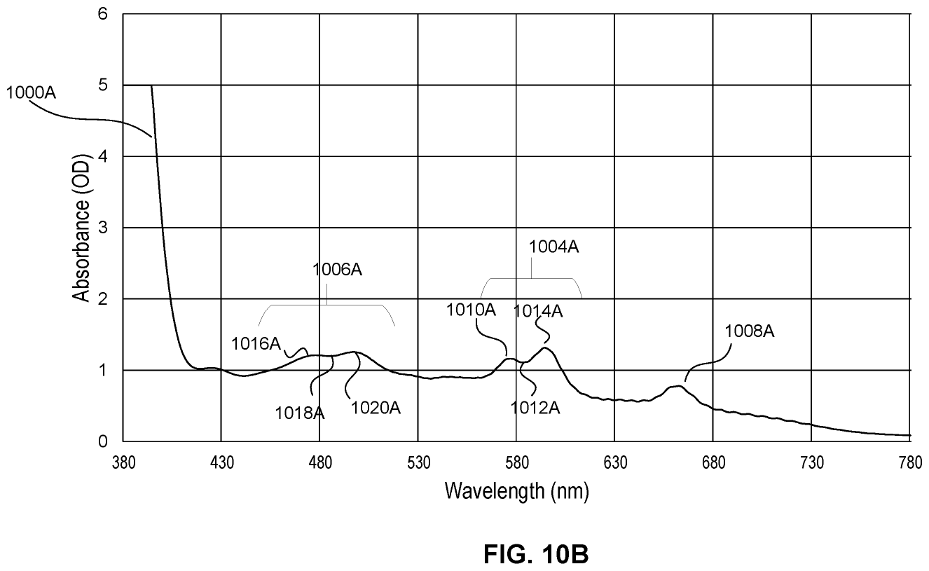

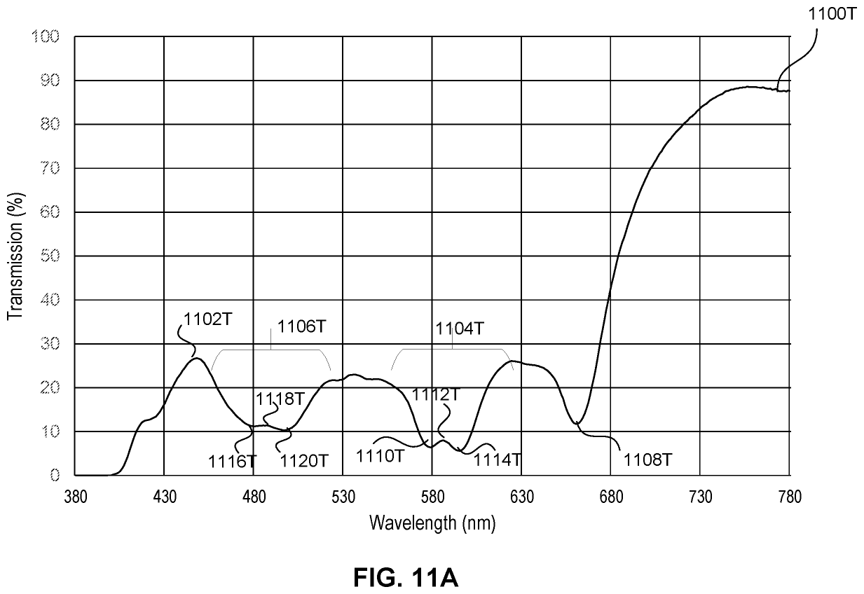

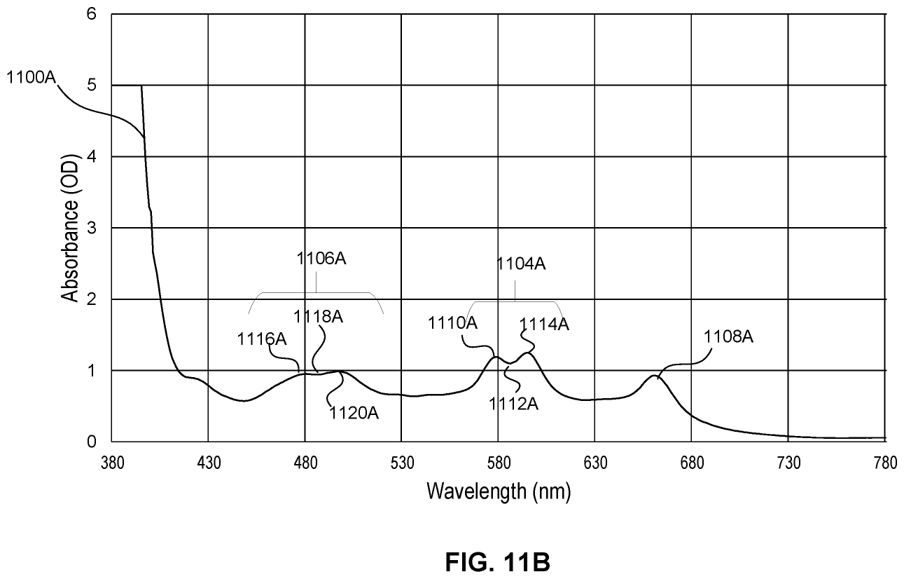

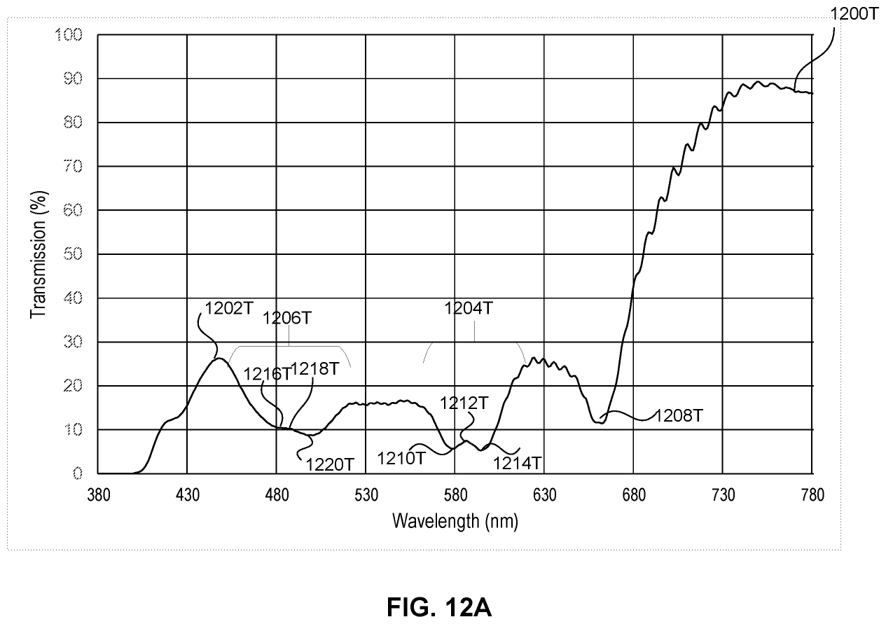

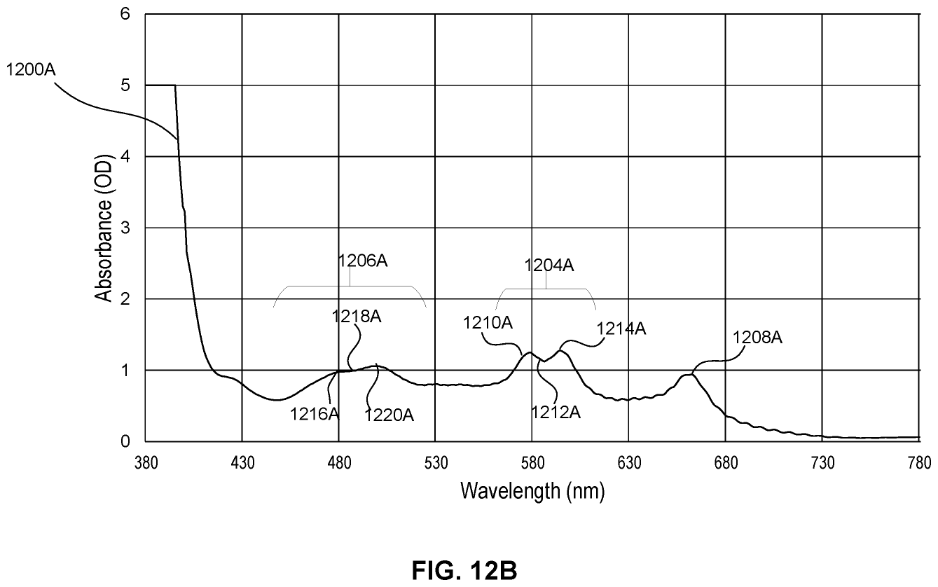

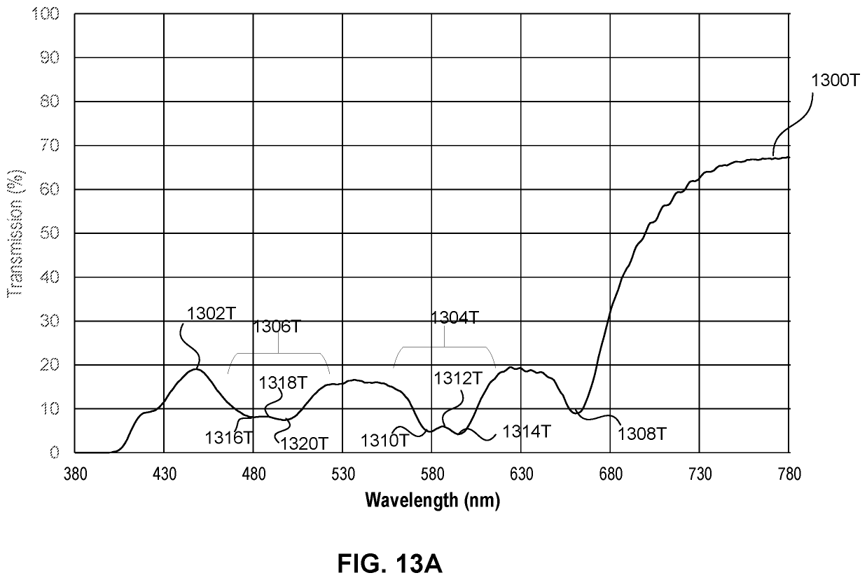

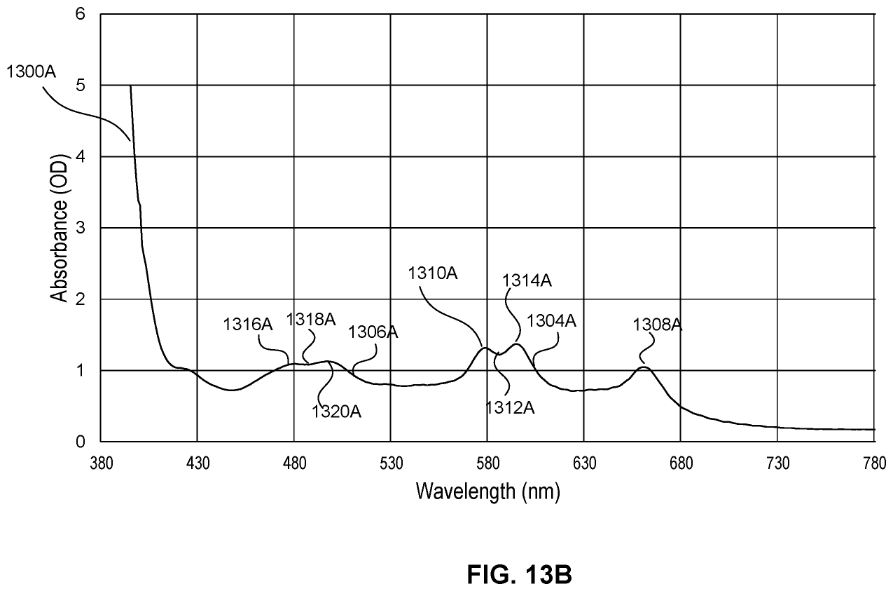

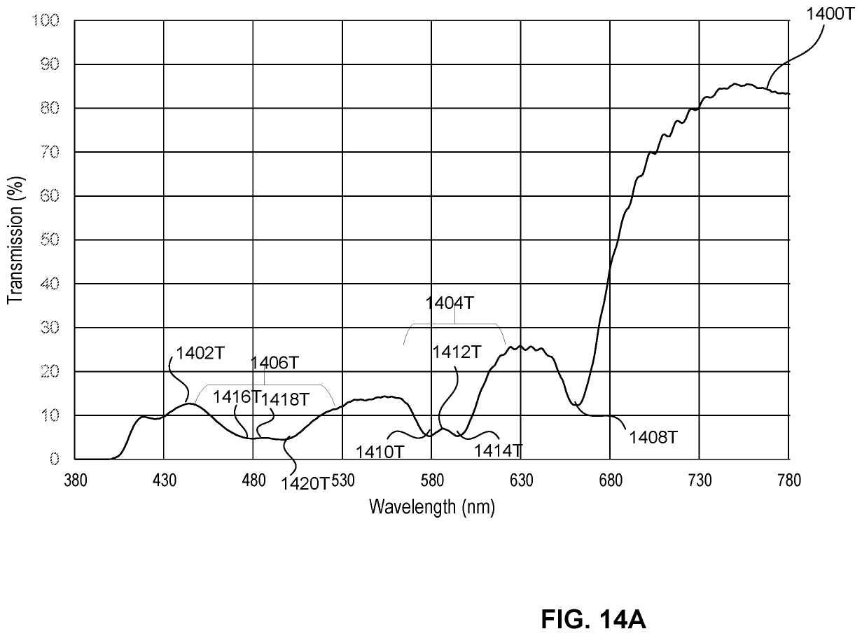

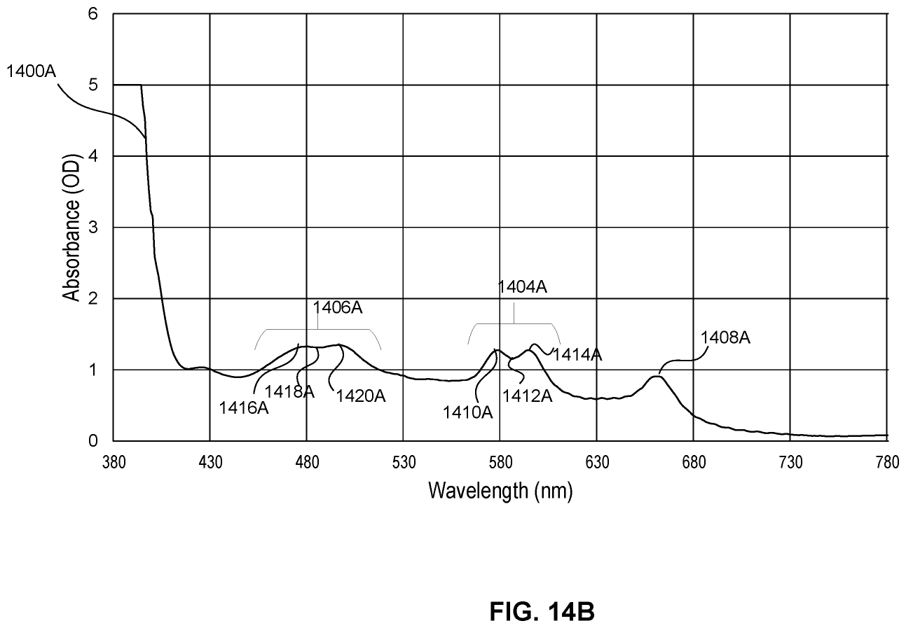

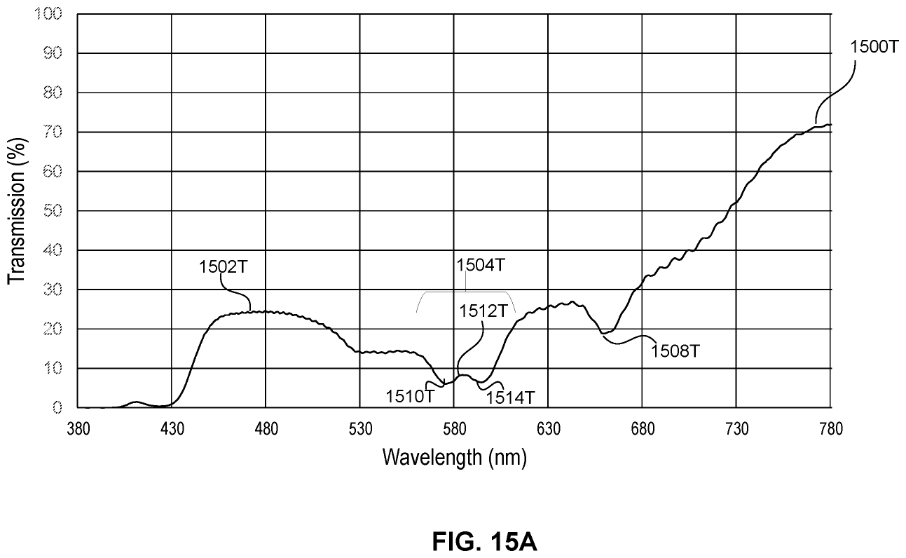

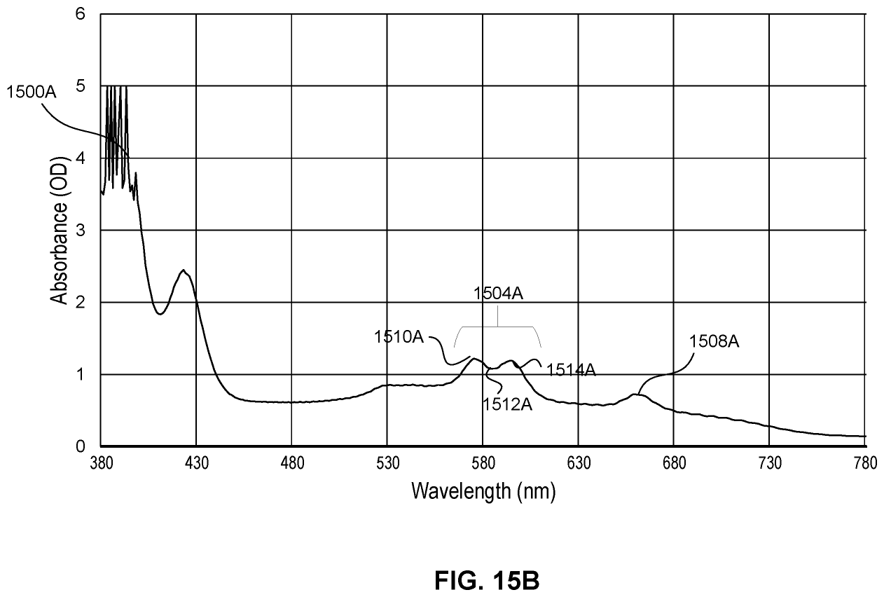

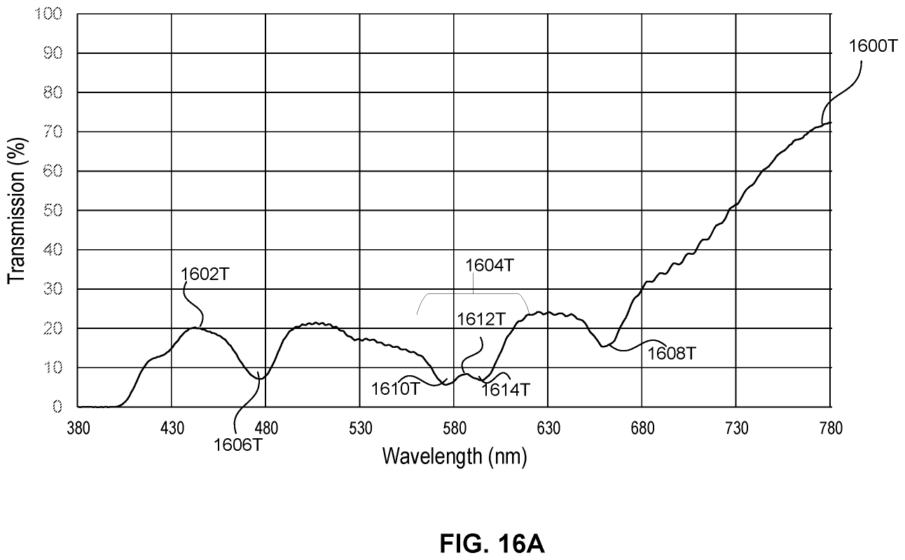

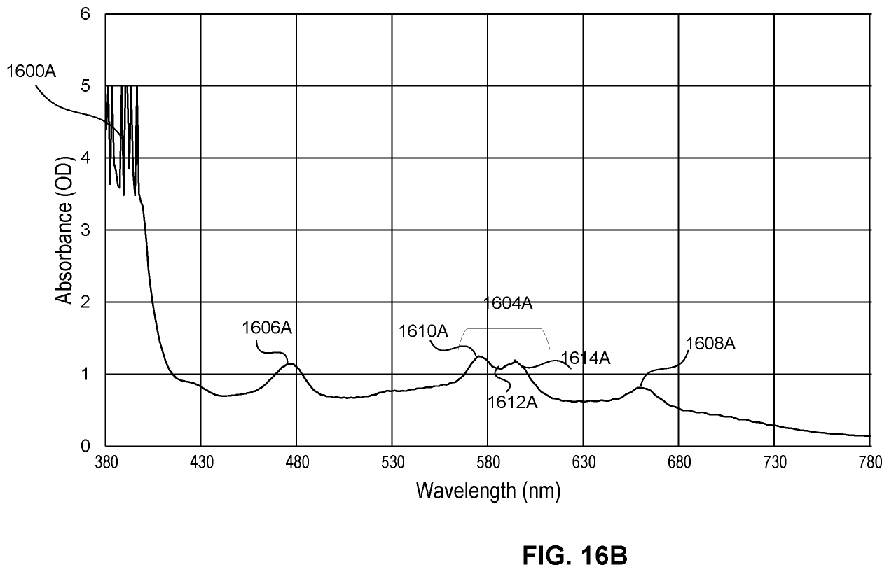

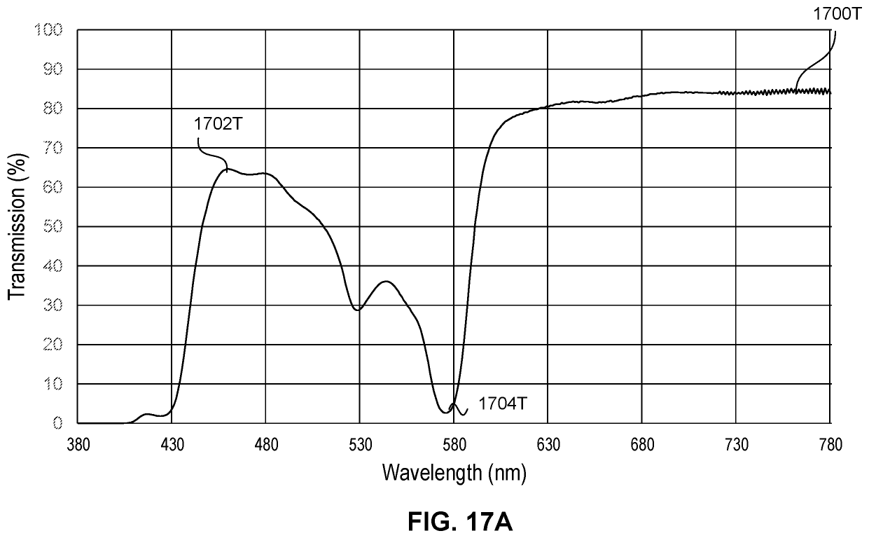

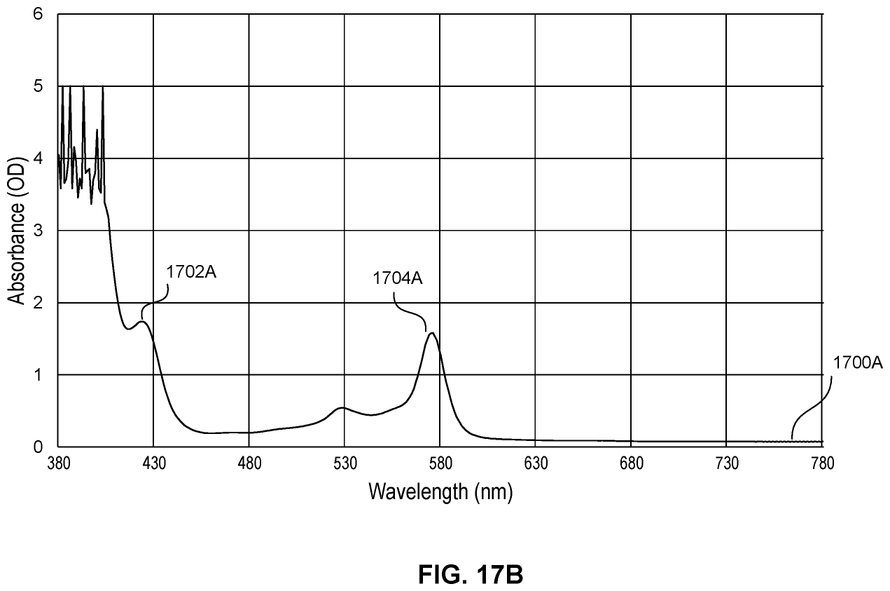

FIG. 3A illustrates an optical transmittance profile 300T, according to some embodiments. FIG. 3B illustrates a respective optical absorbance profile 300A, according to some embodiments. It would be understood that optical characteristics exhibited in FIGS. 3A and 3B are merely illustrative and not intended to be limiting, unless mentioned otherwise. For example, optical transmittance profile 300T can represent an optical transmittance of optical filter 104, lens 200, lens 220, or lens 240 that includes a chroma enhancement filter.

Optical transmittance profile 300T can include one or more transmittance valleys, such as valleys 304T, 306T, 308T each having a minimum transmittance in one or more spectral bands. Such transmittance valleys (e.g., valleys 304T, 306T, 308T) can filter out or attenuate undesired spectral wavelengths of light. Accordingly, optical transmittance profile 300T can provide chroma enhancement in the one or more spectral bands while maintaining a minimal desired transmission at each wavelength. Optical transmittance profile 300T can also include one or more transmittance peaks such as peak 302T.

A transmittance valley can be defined by a position of a minimum optical transmittance in a portion of a spectral band between lower and upper edge portions of the spectral band, the lower and upper edge portions having an optical transmittance that is substantially greater than the minimum optical transmittance. On the other hand, an absorbance peak can be defined by a position of a maximum absorbance in a portion of a spectral band between lower and upper edge portions of the spectral band, the upper and lower edge portions having an optical absorbance substantially below the maximum absorbance. An optical transmittance valley can be associated with a respective optical absorbance peak. For example, an optical filter can have an optical characteristic including an optical reflectivity R, an optical transmittance T, an optical absorptance A_{P}, and an optical absorbance A_{B}. Optical absorptance A_{P} can be about equal to (1−T−R), and optical absorbance A_{B} can be about equal to the magnitude of the logarithm of optical transmittance T, such as −log₁₀(T). In some embodiments, the optical reflectivity R can be relatively wavelength-insensitive as compared to the optical transmittance T, the optical absorptance A_{P}, and the optical absorbance A_{B}. Therefore, in some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 304T, 306T, and 308T illustrated in optical transmittance profile 300T can be hereinafter represented as absorbance peaks 304A, 306A, and 308A in optical absorbance profile 300A. As such, in referring to FIG. 3B, optical absorbance profile 300A can include an absorbance peak 304A associated with valley 304T, an absorbance peak 306A associated with valley 306T, and an absorbance peak 308A associated with valley 308T.

In some embodiments, one or more of the transmittance valleys may include a saddleback transmittance valley. A saddleback transmittance valley may include a minimum optical transmittance followed by a local maximum optical transmittance, followed by another minimum optical transmittance (e.g., transmittance at increasing wavelengths). The middle portion of the spectral band between the lower and upper edge portions may include a local maximum optical transmittance. In some aspects, the minimum optical transmittance may be a minimum transmittance relative to transmittance at surrounding wavelengths. In some embodiments, the saddleback transmittance valley can be defined by a position of the local maximum optical transmittance. On the other hand, a saddleback absorbance peak can have a local minimum absorbance. The middle portion of the spectral band between the lower and upper edge portions may include the local minimum absorbance. The local minimum absorbance may be positioned between two maximum absorbance. The upper and lower edge portions may have an optical absorbance substantially below the local minimum absorbance and the maximum absorbance. The saddleback absorbance peak may be defined by a position of the local minimum absorbance.

Referring to FIG. 3A, in some embodiments, transmittance valley 304T can be a saddleback transmittance valley. Transmittance valley 304T may include a first minimum 310T, a local maximum 312T, and a second minimum 314T.

Local maximum 312T is at a wavelength from about 570 nm to about 600 nm, from about 575 nm to about 595 nm, from about 580 nm to about 590 nm, about 582 nm, about 583 nm, about 584 nm, about 585 nm, or about 586 nm. First minimum 310T is at a wavelength from about 570 nm to about 600 nm, from about 575 nm to about 580 nm, about 575 nm, about 576 nm, about 577 nm, about 578 nm, about 579 nm, or about 580 nm. Second minimum 314T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 312T is from about 10% to about 40%, from about 10% to about 30%, from about 20% to about 25%, or about 24%. In some embodiments, transmittance at first minimum 310T is greater than about 5%, greater than about 10%, greater than about 20% and less than about 30%, greater than about 20% and less than about 25%, about 21%, about 22%, or about 23%. In some embodiments, transmittance at second minimum 314T is greater than about 5%, greater than about 10%, greater than about 10% and less than about 15%, about 11%, about 12%, about 13%, or about 14%.

In some embodiments, a difference in transmittance between transmittance at first minimum 310T and transmittance at local maximum 312T is less than about 5%, less than about 4%, less than about 3%, or less than about 2%. In some aspects, a difference in transmittance at local maximum 312T and transmittance at second minimum 314T is greater than about 5% and less than about 15%, greater than about 10% and less than 15%, about 11%, or about 12%.

As discussed previously herein, transmittance valley 304T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 310T, second minimum 314T, and local maximum 312T. For example, a difference in transmittance between a transmittance at the lower edge portion and the first minimum 310T may be between about 30% to about 35%. A difference between a transmittance at the upper edge portion and second minimum 314T is between about 35% to about 55%, or between about 50% to about 55%.

Each transmittance valley in optical transmittance profile 300T can have a respective transmittance bandwidth defined as a full width of the each transmittance valley at certain offset from the minimum transmittance of the each transmittance valley, such as the minimum transmittance plus 1%, the minimum transmittance plus 5%, the minimum transmittance plus 10%, the minimum transmittance plus 15%, or the minimum transmittance plus 30%. For example, if the minimum transmittance is 20%, the bandwidth of the minimum transmittance plus 10% would be measured as corresponding to 30% transmittance.

In some embodiments, transmittance valley 304T can have a transmittance bandwidth of less than about 40 nm, less than about 20 nm, or less than about 15 nm at the minimum transmittance plus 5% (transmittance at second minimum 314T). In some embodiments, transmittance valley 304T can have a transmittance bandwidth of less than about 40 nm, less than about 30 nm, or less than about 20 nm at the minimum transmittance plus 10%. In some embodiments, transmittance valley 304T can have a transmittance bandwidth of less than about 40 nm or less than about 35 nm at the minimum transmittance plus 15%. In some embodiments, transmittance valley 304T can have a transmittance bandwidth of less than about 40 nm or less than about 35 nm at the minimum transmittance plus 20%.

In some embodiments, transmittance valley 308T can have a transmittance bandwidth of less than about 15 nm, less than about 15 nm, or less than about 20 nm at minimum transmittance plus 5%, the minimum transmittance plus 10%, or the minimum transmittance plus 20%, respectively.

In some embodiments, transmittance valley 306T can have a transmittance bandwidth of less than about 25 nm, less than about 30 nm, or less than about 50 nm at minimum transmittance plus 5%, the minimum transmittance plus 10%, or the minimum transmittance plus 20%, respectively.

In some embodiments, the maximum transmittance of the transmittance peak 302T is greater than or equal to about 50%, is greater than or equal to about 55%, or is greater than or equal to about 60%.

In some embodiments, the maximum transmittance of transmittance peak 302T is at a wavelength from about 430 nm to about 480 nm, or from about 430 nm to about 450 nm.

In some embodiments, a minimum transmittance of the valley 306T is less than about 25%, between about 15% and about 20%, or about 16%.

In some embodiments, the minimum transmittance of valley 306T is at a wavelength from about 465 nm to about 505 nm, from about 485 nm to about 505 nm, from about 490 nm to about 505 nm, about 495 nm to about 505 nm, at about 498 nm, at about 499 nm, or at about 500 nm.

In some embodiments, a minimum transmittance of the valley 308T is from about 25% to about 35%, or from about 25% to about 30%.

In some embodiments, the minimum transmittance of valley 308T is at a wavelength from about 630 nm to about 680 nm, from about 650 nm to about 670 nm, or about 660 nm to about 665 nm.

Referring to FIG. 3B, in some embodiments, absorbance peak 304A can be a saddleback peak. Absorbance peak 304A can include a first maximum 310A, a local minimum 312A, and a second maximum 314A. First maximum 310A can be associated with first minimum 310T. Local maximum 312T can be associated with local minimum 312A. Second maximum 314A can be associated with second minimum 314T.

Local minimum 312A is at a wavelength from about 570 nm to about 600 nm, from about 575 nm to about 595 nm, from about 580 nm to about 590 nm, about 582 nm, about 583 nm, about 584 nm, about 585 nm, or about 586 nm. First maximum 310A is at a wavelength from about 570 nm to about 600 nm, from about 575 nm to about 580 nm, at about 575 nm, at about 576 nm, at about 577 nm, at about 578 nm, at about 579 nm, or at about 580 nm. Second maximum 314A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

Absorbance peak 304A can have a maximum optical density (e.g., optical absorbance A_{B}) from about 0.5 to about 1.5, from about 0.5 to about 1, about 0.9, about 0.8, about 0.7, or about 0.6, and can be positioned in a spectral band from about 570 nm to about 600 nm. Accordingly, optical densities at a lower edge portion (e.g., closer to about 565 nm) and a upper edge portion (e.g., closer to about 610 nm) of the spectral band (e.g., between about 570 nm and about 600 nm) can be less than that of absorbance peak 304A. Namely, absorbance peak 304A can have greater absorbance than the lower edge and the upper edge portions of the spectral band. Similarly, absorbance peak 306A can have a maximum optical density less than or equal to 1, less than or equal to 0.8, or between about 0.7 to about 0.9, and can be positioned in a spectral band from about 485 nm to about 505 nm.

In some embodiments, optical density at local minimum 312A is from about 0.5 to about 1, from about 0.5 to about 0.75, or from about 0.55 to about 0.65. In some embodiments, optical density at first maximum 310A is from about 0.5 to about 1, from about 0.5 to about 0.75, or from about 0.55 to about 0.65. In some embodiments, optical density at second minimum 314A is from about 0.5 to about 1.25, from about 0.75 to about 1, or from about 0.85 to about 1.

In some embodiments, absorbance peak 306A can have a maximum optical density from about 0.5 to about 1, from about 0.6 to about 0.8, or from about 0.7 to about 0.8.

In some embodiments, a scotopic transmission of the lens 200 is less than or equal to about 45%, about 40%, or about 41%.

In some embodiments, a visible light transmission (as defined by EN1836) of lens 200 is from about 20% to about 60%, from about 30% to about 50%, from about 35% to about 45%, about 41%, about 42%, or about 43%.

FIG. 4A illustrates an optical transmittance profile 400T, according to some embodiments. FIG. 4B illustrates a respective optical absorbance profile 400A, according to some embodiments. It would be understood that optical characteristics exhibited in FIGS. 4A and 4B are merely illustrative and not intended to be limiting, unless mentioned otherwise. For example, optical transmittance profile 400T can represent an optical transmittance of optical filter 104, lens 200, lens 220, or lens 240 that includes a chroma enhancement filter.

Optical transmittance profile 400T can include one or more transmittance valleys, such as valleys 404T, 406T, 408T each having a minimum transmittance in one or more spectral bands. Such transmittance valleys (e.g., valleys 404T, 406T, 408T) can filter out or attenuate undesired spectral wavelengths of light. Accordingly, optical transmittance profile 400T can provide chroma enhancement in the one or more spectral bands while maintaining a minimal desired transmission at each wavelength. Optical transmittance profile 400T can also include one or more transmittance peaks such as peak 402T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 404T, 406T, and 408T illustrated in optical transmittance profile 400T can be hereinafter represented as absorbance peaks 404A, 406A, and 408A in optical absorbance profile 400A. As such, in referring to FIG. 4B, optical absorbance profile 400A can include an absorbance peak 404A associated with valley 404T, an absorbance peak 406A associated with valley 406T, and an absorbance peak 408A associated with valley 408T.

Referring to FIG. 4A, in some embodiments, transmittance valley 404T can be a saddleback transmittance valley. Transmittance valley 404T may include a first minimum 410T, a local maximum 412T, and a second minimum 414T.

Local maximum 412T is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First minimum 410T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 414T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 412T is from about 10% to about 40%, from about 10% to about 30%, from about 10% to about 20%, from about 15% to about 20%, about 16%, about 17%, or about 18%. In some embodiments, transmittance at first minimum 410T is greater than about 5%, greater than about 10%, between about 10% and about 20%, between 15% to about 20%, about 16%, or about 17%. In some embodiments, transmittance at second minimum 414T is greater than about 5%, greater than about 8%, greater than about 8% and less than about 12%, about 9%, about 10%, about 11%, or about 12%.

In some embodiments, a difference in transmittance between transmittance at first minimum 410T and transmittance at local maximum 412T is less than about 5%, less than about 4%, less than about 3%, or less than about 2%. In some aspects, a difference in transmittance at local maximum 412T and transmittance at second minimum 414T is greater than about 5% and less than about 10%, about 7%, or about 8%.

As discussed previously herein, transmittance valley 404T can be between a lower edge portion (e.g., closer to about 565 nm) and an upper edge portion (e.g., closer to about 610 nm) of the spectral band (e.g., between about 570 nm and about 600 nm). Transmittance at the lower edge portion and the upper edge portion can be greater than that of first minimum 410T, second minimum 414T, local maximum 412T. For example, a difference in transmittance between a transmittance at the lower edge portion and the first minimum 410T may be between about 15% to about 25%. A difference between a transmittance at the upper edge portion and second minimum 414T is between about 30% to about 45%, or between about 35% to about 40%.

In some embodiments, transmittance valley 404T can have a transmittance bandwidth of less than about 40 nm, less than about 30 nm, or less than about 20 nm at the minimum transmittance plus 5% (transmittance at second minimum 414T). In some embodiments, transmittance valley 404T can have a transmittance bandwidth of less than about 40 nm or less than about 35 nm at the minimum transmittance plus 10%. In some embodiments, transmittance valley 404T can have a transmittance bandwidth of less than about 40 nm at the minimum transmittance plus 15%. In some embodiments, transmittance valley 404T can have a transmittance bandwidth of less than about 45 nm at the minimum transmittance plus 20%.

In some embodiments, transmittance valley 408T can have a transmittance bandwidth of less than about 15 nm, less than about 15 nm, or less than about 20 nm at minimum transmittance plus 5%, the minimum transmittance plus 10%, or the minimum transmittance plus 20%, respectively.

In some embodiments, transmittance valley 406T can have a transmittance bandwidth of less than about 25 nm, less than about 30 nm, or less than about 50 nm at minimum transmittance plus 5%, the minimum transmittance plus 10%, or the minimum transmittance plus 20%, respectively.

In some embodiments, the maximum transmittance of the transmittance peak 402T is greater than or equal to about 30%, is greater than or equal to about 35%, or is greater than or equal to about 35% and less than or equal to about 40%.

In some embodiments, the maximum transmittance of transmittance peak 402T is at a wavelength from about 430 nm to about 480 nm, or from about 430 nm to about 450 nm.

In some embodiments, a minimum transmittance of the valley 406T is less than or equal to about 25%, between about 10% and about 15%, about 11%, or about 12%, or about 13%.

In some embodiments, the minimum transmittance of valley 406T is at a wavelength from about 465 nm to about 505 nm, from about 485 nm to about 505 nm, from about 490 nm to about 505 nm, about 495 nm to about 505 nm, at about 498 nm, at about 499 nm, or at about 500 nm.

In some embodiments, a minimum transmittance of the valley 408T is between about 15% to about 35%, or between about 20% to about 25%.

In some embodiments, the minimum transmittance of valley 408T is at a wavelength from about 630 nm to about 680 nm, from about 650 nm to about 670 nm, or about 660 nm to about 665 nm.

Referring to FIG. 4B, in some embodiments, absorbance peak 404A can be a saddleback peak. Absorbance peak 404A can include a first maximum 410A, a local minimum 412A, and a second maximum 414A. First maximum 410A can be associated with first minimum 410T. Local maximum 412T can be associated with local minimum 412A. Second maximum 414A can be associated with second minimum 414T.

Local minimum 412A is at a wavelength from about 570 nm to about 600 nm, from about 575 nm to about 595 nm, from about 580 nm to about 590 nm, about 582 nm, at about 583 nm, at about 584 nm, at about 585 nm, or at about 586 nm. First maximum 410A is at a wavelength from about 570 nm to about 600 nm, from about 575 nm to about 580 nm, at about 575 nm, at about 576 nm, at about 577 nm, at about 578 nm, at about 579 nm, or at about 580 nm. Second maximum 414A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 412A is from about 0.5 to about 1, from about 0.6 to about 0.8, or from about 0.7 to about 0.8. In some embodiments, optical density at first maximum 410A is from about 0.5 to about 1, from about 0.75 to about 0.95, or from about 0.8 to about 0.82. In some embodiments, optical density at second minimum 414A is from about 0.75 to about 1.25, from about 0.9 to about 1.1, or from about 1 to about 1.05.

In some embodiments, absorbance peak 406A can have a maximum optical density from about 0.75 to about 1.25, from about 0.85 to about 1.15, or from about 0.9 to about 1.

In some embodiments, absorbance peak 408A can have a maximum optical density from about 0.4 to about 0.8, from about 0.5 to about 0.7, or from about 0.6 to about 0.7.

In some embodiments, a scotopic transmission of the lens 200 is less than or equal to about 45%, is less than about 35%, is less than about 30%, about 26%, about 27%, or about 28%.

In some embodiments, a visible light transmission (as defined by EN1836) of lens 200 is from about 10% to about 50%, from about 15% to about 45%, from about 20% to about 40%, from about 20% to about 35%, or from about 25% to about 30%.

FIG. 5A illustrates an optical transmittance profile 500T, according to some embodiments. FIG. 5B illustrates a respective optical absorbance profile 500A, according to some embodiments. It would be understood that optical characteristics exhibited in FIGS. 5A and 5B are merely illustrative and not intended to be limiting, unless mentioned otherwise. For example, optical transmittance profile 500T can represent an optical transmittance of optical filter 104, lens 200, lens 220, or lens 240 that includes a chroma enhancement filter.

Optical transmittance profile 500T can include one or more transmittance valleys, such as valleys 504T, 506T, 508T each having a minimum transmittance in one or more spectral bands. Such transmittance valleys (e.g., valleys 504T, 506T, 508T) can filter out or attenuate undesired spectral wavelengths of light. Accordingly, optical transmittance profile 500T can provide chroma enhancement in the one or more spectral bands while maintaining a minimal desired transmission at each wavelength. Optical transmittance profile 500T can also include one or more transmittance peaks such as peak 502T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 504T, 506T, and 508T illustrated in optical transmittance profile 500T can be hereinafter represented as absorbance peaks 504A, 506A, and 508A in optical absorbance profile 500A. As such, in referring to FIG. 5B, optical absorbance profile 500A can include an absorbance peak 504A associated with valley 504T, an absorbance peak 506A associated with valley 506T, and an absorbance peak 508A associated with valley 508T.

Referring to FIG. 5A, in some embodiments, transmittance valley 504T can be a saddleback transmittance valley. Transmittance valley 504T may include a first minimum 510T, a local maximum 512T, and a second minimum 514T.

Local maximum 512T is at a wavelength from about 570 nm to about 600 nm, from about 575 nm to about 595 nm, from about 580 nm to about 590 nm, about 582 nm, about 583 nm, about 584 nm, about 585 nm, or about 586 nm. First minimum 510T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 514T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 512T is from about 10% to about 30%, from about 15% to about 25%, from about 17% to about 22%, about 18%, about 19%, or about 20%. In some embodiments, transmittance at first minimum 510T is greater than about 5%, greater than about 10%, between about 10% and about 25%, between 15% to about 20%, about 17%, about 18%, or about 19%. In some embodiments, transmittance at second minimum 514T is greater than about 5%, greater than about 8%, greater than about 8% and less than about 12%, about 8%, about 9%, about 10%, or about 11%.

In some embodiments, a difference in transmittance between transmittance at first minimum 510T and transmittance at local maximum 512T is less than about 5%, less than about 4%, less than about 3%, or less than about 2%. In some aspects, a difference in transmittance at local maximum 512T and transmittance at second minimum 514T is greater than about 5% and less than about 15%, about 9%, about 10%, or about 11%.

As discussed previously herein, transmittance valley 504T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 510T, second minimum 514T, local maximum 512T. For example, a difference in transmittance between a transmittance at the lower edge portion and the first minimum 510T may be between about 15% to about 30%, between about 20% to about 30%, or about 27%. A difference between a transmittance at the upper edge portion and second minimum 514T is between about 35% to about 55%, or between about 40% to about 50%.

In some embodiments, transmittance valley 504T can have a transmittance bandwidth of less than about 40 nm, less than about 20 nm, or less than about 15 nm at the minimum transmittance plus 5% (transmittance at second minimum 514T). In some embodiments, transmittance valley 504T can have a transmittance bandwidth of less than about 40 nm, less than about 30 nm, or less than about 20 nm at the minimum transmittance plus 10%. In some embodiments, transmittance valley 504T can have a transmittance bandwidth of less than about 40 nm or less than about 35 nm at the minimum transmittance plus 15%. In some embodiments, transmittance valley 504T can have a transmittance bandwidth of less than about 40 nm at the minimum transmittance plus 20%.

In some embodiments, transmittance valley 508T can have a transmittance bandwidth of less than about 15 nm, less than about 15 nm, or less than about 20 nm at minimum transmittance plus 5%, the minimum transmittance plus 10%, or the minimum transmittance plus 20%, respectively.

In some embodiments, transmittance valley 506T can have a transmittance bandwidth of less than about 25 nm, less than about 30 nm, or less than about 50 nm at minimum transmittance plus 5%, the minimum transmittance plus 10%, or the minimum transmittance plus 20%, respectively.

In some embodiments, the maximum transmittance of the transmittance peak 502T is greater than or equal to about 30%, is greater than or equal to about 35%, or is greater than or equal to about 40% and less than or equal to about 50%.

In some embodiments, the maximum transmittance of transmittance peak 502T is at a wavelength from about 430 nm to about 480 nm, or from about 430 nm to about 450 nm.

In some embodiments, a minimum transmittance of the valley 506T is less than or equal to about 25%, between about 7% and about 18%, about 10% to about 15%, about 12%, about 13%, or about 14%.

In some embodiments, the minimum transmittance of valley 506T is at a wavelength from about 465 nm to about 505 nm, from about 485 nm to about 505 nm, from about 490 nm to about 505 nm, about 495 nm to about 505 nm, at about 498 nm, at about 499 nm, or at about 500 nm.

In some embodiments, a minimum transmittance of the valley 508T is between about 20% to about 30%, or between about 22% to about 26%.

In some embodiments, the minimum transmittance of valley 508T is at a wavelength from about 630 nm to about 680 nm, from about 650 nm to about 670 nm, about 660 nm to about 665 nm, or at about 662 nm.

Referring to FIG. 5B, in some embodiments, absorbance peak 504A can be a saddleback peak. Absorbance peak 504A can include a first maximum 510A, a local minimum 512A, and a second maximum 514A. First maximum 510A can be associated with first minimum 510T. Local maximum 512T can be associated with local minimum 512A. Second maximum 514A can be associated with second minimum 514T.

Local minimum 512A is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First maximum 510A is at a wavelength from about 570 nm to about 600 nm, from about 575 nm to about 580 nm, at about 575 nm, at about 576 nm, at about 577 nm, at about 578 nm, at about 579 nm, or at about 580 nm. Second maximum 514A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 512A is from about 0.5 to about 1, from about 0.6 to about 0.8, or from about 0.65 to about 0.75. In some embodiments, optical density at first maximum 510A is from about 0.5 to about 1, or from about 0.7 to about 0.8. In some embodiments, optical density at second minimum 514A is from about 0.75 to about 1.25, from about 0.9 to about 1.1, or from about 0.95 to about 1.05.

In some embodiments, absorbance peak 506A can have a maximum optical density from about 0.7 to about 1.1, from about 0.75 to about 1.05, or from about 0.85 to about 1.

In some embodiments, absorbance peak 508A can have a maximum optical density from about 0.4 to about 0.8, from about 0.5 to about 0.7, or from about 0.6 to about 0.65.

In some embodiments, a scotopic transmission of the lens 200 is less than or equal to about 45%, is less than about 40%, is less than about 35%, about 34%, about 33%, or about 32%.

In some embodiments, a visible light transmission (as defined by EN1836) of lens 200 is from about 15% to about 55%, from about 25% to about 45%, from about 30% to about 40%, about 34%, about 35%, or about 36%.

FIG. 6A illustrates an optical transmittance profile 600T, according to some embodiments. FIG. 6B illustrates a respective optical absorbance profile 600A, according to some embodiments. It would be understood that optical characteristics exhibited in FIGS. 6A and 6B are merely illustrative and not intended to be limiting, unless mentioned otherwise. For example, optical transmittance profile 600T can represent an optical transmittance of optical filter 104, lens 200, lens 220, or lens 240 that includes a chroma enhancement filter.

Optical transmittance profile 600T can include one or more transmittance valleys, such as valleys 604T, 606T, 608T each having a minimum transmittance in one or more spectral bands. Such transmittance valleys (e.g., valleys 604T, 606T, 608T) can filter out or attenuate undesired spectral wavelengths of light. Accordingly, optical transmittance profile 600T can provide chroma enhancement in the one or more spectral bands while maintaining a minimal desired transmission at each wavelength. Optical transmittance profile 600T can also include one or more transmittance peaks such as peak 602T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 604T, 606T, and 608T illustrated in optical transmittance profile 600T can be hereinafter represented as absorbance peaks 604A, 606A, and 608A in optical absorbance profile 600A. As such, in referring to FIG. 6B, optical absorbance profile 600A can include an absorbance peak 604A associated with valley 604T, an absorbance peak 606A associated with valley 606T, and an absorbance peak 608A associated with valley 608T.

Referring to FIG. 6A, in some embodiments, transmittance valley 604T can be a saddleback transmittance valley. Transmittance valley 604T may include a first minimum 610T, a local maximum 612T, and a second minimum 614T.

Local maximum 612T is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First minimum 610T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 614T is at a wavelength from about 580 nm to about 600 nm, from about 590 nm to about 600 nm, from about 592 nm to about 598 nm, at about 593 nm, at about 594 nm, about 595 nm, about 596 nm, or about 597 nm.

In some embodiments, transmittance at local maximum 612T is from about 1% to about 20%, from about 5% to about 15%, from about 7% to about 10%, about 8%, or about 9%. In some embodiments, transmittance at first minimum 610T is greater than about 5%, greater than about 6%, between about 5% and about 10%, about 7%, about 8%, or about 9%. In some embodiments, transmittance at second minimum 614T is greater than about 1%, greater than about 2%, greater than about 3% and less than about 5%, about 4%, or about 5%.

In some embodiments, a difference in transmittance between transmittance at first minimum 610T and transmittance at local maximum 612T is less than about 5%, less than about 4%, less than about 3%, less than about 2%, or less than about 1%. In some aspects, a difference in transmittance at local maximum 612T and transmittance at second minimum 614T is greater than about 2% and less than about 6%, about 3%, about 5%, or about 4%.

As discussed previously herein, transmittance valley 604T can be between a lower edge portion (e.g., closer to about 565 nm) and an upper edge portion (e.g., closer to about 610 nm) of the spectral band (e.g., between about 570 nm and about 600 nm). Transmittance at the lower edge portion and the upper edge portion can be greater than that of first minimum 610T, second minimum 614T, local maximum 612T. For example, a difference in transmittance between a transmittance at the lower edge portion and the first minimum 610T may be between about 5% to about 15%, between about 7% to about 12%, about 10%, or about 11%. A difference between a transmittance at the upper edge portion and second minimum 614T is between about 10% to about 30%, between about 15% to about 25%, about 17%, about 18%, or about 19%.

In some embodiments, transmittance valley 604T can have a transmittance bandwidth of less than about 45 nm, less than about 40 nm, or less than about 35 nm at the minimum transmittance plus 5% (transmittance at second minimum 614T). In some embodiments, transmittance valley 604T can have a transmittance bandwidth of less than about 50 nm, less than about 45 nm, or less than about 40 nm at the minimum transmittance plus 10%.

In some embodiments, transmittance valley 608T can have a transmittance bandwidth of less than about 25 nm at minimum transmittance plus 5% and a transmittance bandwidth of less than about 25 nm at minimum transmittance plus 10%, respectively.

In some embodiments, the maximum transmittance of the transmittance peak 602T is greater than or equal to about 5%, is greater than or equal to about 10%, or is greater than or equal to about 20% and less than or equal to about 25%.

In some embodiments, the maximum transmittance of transmittance peak 602T is at a wavelength from about 430 nm to about 480 nm, from about 435 nm to about 455 nm, or from about 445 nm to about 450 nm.

In some embodiments, transmittance valley 606T can be a saddleback transmittance valley. Transmittance valley 606T may include a first minimum 616T, a local maximum 618T, and a second minimum 620T.

In some embodiments, the second minimum 620T of valley 606T is at a wavelength from about 465 nm to about 505 nm, from about 485 nm to about 505 nm, from about 490 nm to about 505 nm, about 495 nm to about 505 nm, at about 497 nm, at about 498 nm, at about 499 nm, or at about 500 nm.

In some embodiments, local maximum 618T is at wavelength from about 475 nm to about 495 nm, from about 480 nm to about 490 nm, at about 483 nm, at about 484 nm, or at about 485 nm. In some embodiments, first minimum 616T is at wavelength from about 470 nm to about 490 nm, from about 475 nm to about 485 nm, at about 478 nm, at about 479 nm, or at about 480 nm.

In some embodiments, a minimum transmittance of the valley 606T is less than or equal to about 25%, between about 7% and about 18%, about 10% to about 15%, about 11%, about 12%, about 13%, or about 14%.

In some embodiments, a minimum transmittance of the valley 608T is between about 5% to about 20%, between about 10% to about 15%, about 13%, about 14%, or about 15%.

In some embodiments, the minimum transmittance of valley 608T is at a wavelength from about 630 nm to about 680 nm, from about 650 nm to about 670 nm, about 655 nm to about 665 nm, at about 658 nm, at about 659 nm, or at about 660 nm.

Referring to FIG. 6B, in some embodiments, absorbance peak 604A can be a saddleback peak. Absorbance peak 604A can include a first maximum 610A, a local minimum 612A, and a second maximum 614A. First maximum 610A can be associated with first minimum 610T. Local maximum 612T can be associated with local minimum 612A. Second maximum 614A can be associated with second minimum 614T.

Local minimum 612A is at a wavelength from about 570 nm to about 600 nm, from about 575 nm to about 595 nm, from about 580 nm to about 590 nm, at about 581 nm, at about 582 nm, at about 583 nm, at about 584 nm, or at about 585 nm. First maximum 610A is at a wavelength from about 570 nm to about 600 nm, from about 575 nm to about 580 nm, at about 574 nm, at about 575 nm, at about 576 nm, at about 577 nm, at about 578 nm, or at about 579 nm. Second maximum 614A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 612A is from about 0.5 to about 1.5, from about 0.75 to about 1.25, or from about 0.95 to about 1.1. In some embodiments, optical density at first maximum 610A is from about 0.5 to about 1.5, or from about 0.75 to about 1.25. In some embodiments, optical density at second minimum 614A is from about 0.75 to about 1.7, from about 1 to about 1.5, or from about 1.2 to about 1.4.

In some embodiments, absorbance peak 606A can be a saddleback peak. Absorbance peak 606A can include a first maximum 616A, a local minimum 618A, and a second maximum 620A. First maximum 616A can be associated with first minimum 616T. Local maximum 618T can be associated with local minimum 618A. Second maximum 620A can be associated with second minimum 620T.

In some embodiments, absorbance peak 606A can have a maximum optical density from about 0.5 to about 1.5, from about 0.75 to about 1.25, or from about 0.85 to about 1.05.

In some embodiments, absorbance peak 608A can have a maximum optical density from about 0.5 to about 1.2, from about 0.6 to about 1.1, or from about 0.7 to about 0.9.

In some embodiments, a scotopic transmission of the lens 200 is less than or equal to about 35%, is less than about 30%, is less than about 25%, is less than about 20%, about 16%, about 17%, or about 16%.

In some embodiments, a visible light transmission (as defined by EN1836) of lens 200 is from about 5% to about 30%, from about 10% to about 20%, about 14%, about 15%, or about 16%.

FIG. 7A illustrates an optical transmittance profile 700T, according to some embodiments. FIG. 7B illustrates a respective optical absorbance profile 700A, according to some embodiments. It would be understood that optical characteristics exhibited in FIGS. 7A and 7B are merely illustrative and not intended to be limiting, unless mentioned otherwise. For example, optical transmittance profile 700T can represent an optical transmittance of optical filter 104, lens 200, lens 220, or lens 240 that includes a chroma enhancement filter.

Optical transmittance profile 700T can include one or more transmittance valleys, such as valleys 704T, 706T, 708T each having a minimum transmittance in one or more spectral bands. Such transmittance valleys (e.g., valleys 704T, 706T, 708T) can filter out or attenuate undesired spectral wavelengths of light. Accordingly, optical transmittance profile 700T can provide chroma enhancement in the one or more spectral bands while maintaining a minimal desired transmission at each wavelength. Optical transmittance profile 700T can also include one or more transmittance peaks such as peak 702T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 704T, 706T, and 708T illustrated in optical transmittance profile 700T can be hereinafter represented as absorbance peaks 704A, 706A, and 708A in optical absorbance profile 700A. As such, in referring to FIG. 7B, optical absorbance profile 700A can include an absorbance peak 704A associated with valley 704T, an absorbance peak 706A associated with valley 706T, and an absorbance peak 708A associated with valley 708T.

Referring to FIG. 7A, in some embodiments, transmittance valley 704T can be a saddleback transmittance valley. Transmittance valley 704T may include a first minimum 710T, a local maximum 712T, and a second minimum 714T.

Local maximum 712T is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First minimum 710T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 714T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 712T is from about 1% to about 20%, from about 5% to about 15%, from about 7% to about 10%, about 8%, about 9%, or about 10%. In some embodiments, transmittance at first minimum 710T is greater than about 5%, greater than about 6%, between about 5% and about 10%, about 7%, about 8%, or about 9%. In some embodiments, transmittance at second minimum 714T is greater than about 1%, greater than about 2%, greater than about 3% and less than about 6%, about 4%, or about 5%.

In some embodiments, a difference in transmittance between transmittance at first minimum 710T and transmittance at local maximum 712T is less than about 5%, less than about 4%, less than about 3%, less than about 2%, or less than about 1%. In some aspects, a difference in transmittance at local maximum 712T and transmittance at second minimum 714T is greater than about 2% and less than about 6%, about 3%, about 5%, or about 4%.

As discussed previously herein, transmittance valley 704T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 710T, second minimum 714T, local maximum 712T. For example, a difference in transmittance between a transmittance at the lower edge portion and the first minimum 710T may be between about 5% to about 18%, between about 10% to about 15%, or about 12%. A difference between a transmittance at the upper edge portion and second minimum 714T is between about 10% to about 30%, between about 15% to about 25%, about 21%, about 22%, or about 23%.

In some embodiments, transmittance valley 704T can have a transmittance bandwidth of less than about 45 nm at the minimum transmittance plus 10% (transmittance at second minimum 714T).

In some embodiments, transmittance valley 708T can have a transmittance bandwidth of less than about 15 nm at minimum transmittance plus 5% and a transmittance bandwidth of less than about 25 nm at minimum transmittance plus 10%, respectively.

In some embodiments, the maximum transmittance of the transmittance peak 702T is between about 15% to about 35%, between about 20% to about 30%, or about 20% to about 25%.

In some embodiments, the maximum transmittance of transmittance peak 702T is at a wavelength from about 430 nm to about 480 nm, or from about 435 nm to about 455 nm, or from about 445 nm to about 450 nm.

In some embodiments, transmittance valley 706T can be a saddleback transmittance valley. Transmittance valley 706T may include a first minimum 716T, a local maximum 718T, and a second minimum 720T.

In some embodiments, a minimum transmittance of the valley 706T is less than or equal to about 25%, between about 5% and about 25%, about 10% to about 15%, about 11%, about 12%, about 13%, or about 14%.

In some embodiments, the second minimum 720T of transmittance of valley 706T is at a wavelength from about 465 nm to about 505 nm, from about 485 nm to about 505 nm, from about 490 nm to about 505 nm, about 495 nm to about 505 nm, at about 497 nm, at about 498 nm, at about 499 nm, or at about 500 nm.

In some embodiments, local maximum 718T is at wavelength from about 475 nm to about 495 nm, from about 480 nm to about 490 nm, at about 483 nm, at about 484 nm, or at about 485 nm. In some embodiments, first minimum 716T is at wavelength from about 470 nm to about 490 nm, from about 475 nm to about 485 nm, at about 478 nm, at about 479 nm, or at about 480 nm.

In some embodiments, a minimum transmittance of the valley 708T is between about 5% to about 25%, between about 10% to about 20%, about 15%, about 16%, or about 17%.

In some embodiments, the minimum transmittance of valley 708T is at a wavelength from about 630 nm to about 680 nm, from about 650 nm to about 670 nm, about 655 nm to about 665 nm, at about 660 nm, at about 661 nm, at about 662 nm, or at about 663 nm.

Referring to FIG. 7B, in some embodiments, absorbance peak 704A can be a saddleback peak. Absorbance peak 704A can include a first maximum 710A, a local minimum 712A, and a second maximum 714A. First maximum 710A can be associated with first minimum 710T. Local maximum 712T can be associated with local minimum 712A. Second maximum 714A can be associated with second minimum 714T.

Local minimum 712A is at a wavelength from about 570 nm to about 600 nm, from about 575 nm to about 595 nm, from about 580 nm to about 590 nm, at about 581 nm, at about 582 nm, at about 583 nm, at about 584 nm, or at about 585 nm. First maximum 710A is at a wavelength from about 570 nm to about 600 nm, from about 575 nm to about 580 nm, at about 574 nm, at about 575 nm, at about 576 nm, at about 577 nm, at about 578 nm, or at about 579 nm. Second maximum 714A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 712A is from about 0.5 to about 1.5, from about 0.75 to about 1.25, or from about 0.95 to about 1.1. In some embodiments, optical density at first maximum 710A is from about 0.5 to about 1.5, from about 0.75 to about 1.25, or from about 0.95 to about 1.1. In some embodiments, optical density at second minimum 714A is from about 0.75 to about 1.7, from about 1 to about 1.5, or from about 1.2 to about 1.4.

In some embodiments, absorbance peak 706A can be a saddleback peak. Absorbance peak 706A can include a first maximum 716A, a local minimum 718A, and a second maximum 720A. First maximum 716A can be associated with first minimum 716T. Local maximum 718T can be associated with local minimum 718A. Second maximum 720A can be associated with second minimum 720T.

In some embodiments, absorbance peak 706A can have a maximum optical density from about 0.5 to about 1.5, from about 0.75 to about 1.25, or from about 0.85 to about 1.05.

In some embodiments, absorbance peak 708A can have a maximum optical density from about 0.5 to about 1.2, from about 0.6 to about 1.1, or from about 0.7 to about 0.9.

In some embodiments, a scotopic transmission of the lens 200 is less than or equal to about 35%, is less than about 30%, is less than about 25%, is less than about 20%, about 19%, about 18%, or about 17%.

In some embodiments, a visible light transmission (as defined by EN1836) of lens 200 is from about 5% to about 30%, from about 10% to about 20%, about 16%, about 17%, or about 18%.

FIG. 8A illustrates an optical transmittance profile 800T, according to some embodiments. FIG. 8B illustrates a respective optical absorbance profile 800A, according to some embodiments. It would be understood that optical characteristics exhibited in FIGS. 8A and 8B are merely illustrative and not intended to be limiting, unless mentioned otherwise. For example, optical transmittance profile 800T can represent an optical transmittance of optical filter 104, lens 200, lens 220, or lens 240 that includes a chroma enhancement filter.

Optical transmittance profile 800T can include one or more transmittance valleys, such as valleys 804T, 806T, 808T each having a minimum transmittance in one or more spectral bands. Such transmittance valleys (e.g., valleys 804T, 806T, 808T) can filter out or attenuate undesired spectral wavelengths of light. Accordingly, optical transmittance profile 800T can provide chroma enhancement in the one or more spectral bands while maintaining a minimal desired transmission at each wavelength. Optical transmittance profile 800T can also include one or more transmittance peaks such as peak 802T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 804T, 806T, and 808T illustrated in optical transmittance profile 800T can be hereinafter represented as absorbance peaks 804A, 806A, and 808A in optical absorbance profile 800A. As such, in referring to FIG. 8B, optical absorbance profile 800A can include an absorbance peak 804A associated with valley 804T, an absorbance peak 806A associated with valley 806T, and an absorbance peak 808A associated with valley 808T.

Referring to FIG. 8A, in some embodiments, transmittance valley 804T can be a saddleback transmittance valley. Transmittance valley 804T may include a first minimum 810T, a local maximum 812T, and a second minimum 814T.

Local maximum 812T is at a wavelength from about 570 nm to about 600 nm, from about 575 nm to about 595 nm, from about 580 nm to about 590 nm, about 582 nm, about 583 nm, about 584 nm, at about 585 nm, or at about 586 nm. First minimum 810T is at a wavelength from about 570 nm to about 600 nm, from about 575 nm to about 580 nm, about 575 nm, at about 576 nm, at about 577 nm, at about 578 nm, at about 579 nm, or at about 580 nm. Second minimum 814T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 812T is from about 1% to about 15%, from about 5% to about 10%, about 7%, about 8%, or about 9%. In some embodiments, transmittance at first minimum 810T is greater than about 5%, greater than about 6%, between about 5% and about 10%, about 6%, about 7%, or about 8%. In some embodiments, transmittance at second minimum 814T is greater than about 1%, greater than about 2%, greater than about 3% and less than about 6%, about 4%, about 5%, or about 6%.

In some embodiments, a difference in transmittance between transmittance at first minimum 810T and transmittance at local maximum 812T is less than about 5%, less than about 4%, less than about 3%, less than about 2%, or less than about 1%. In some aspects, a difference in transmittance at local maximum 812T and transmittance at second minimum 814T is greater than about 2% and less than about 6%, about 3%, about 4%, or about 5%.

As discussed previously herein, transmittance valley 804T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 810T, second minimum 814T, local maximum 812T. For example, a difference in transmittance between a transmittance at the lower edge portion and the first minimum 810T may be between about 1% to about 16%, between about 5% to about 10%, about 7%, about 8%, or about 9%. A difference between a transmittance at the upper edge portion and second minimum 814T is between about 10% to about 30%, between about 15% to about 25%, about 21%, about 22%, or about 23%.

In some embodiments, transmittance valley 804T can have a transmittance bandwidth of less than about 35 nm at the minimum transmittance plus 5% (transmittance at second minimum 814T) and a transmittance bandwidth of less than about 35 nm at the minimum transmittance plus 10%.

In some embodiments, transmittance valley 808T can have a transmittance bandwidth of less than about 15 nm at minimum transmittance plus 5% and a transmittance bandwidth of less than about 25 nm at minimum transmittance plus 10%, respectively.

In some embodiments, the maximum transmittance of the transmittance peak 802T is between about 15% to about 35%, between about 20% to about 30%, or about 20% to about 25%.

In some embodiments, the maximum transmittance of transmittance peak 802T is at a wavelength from about 430 nm to about 480 nm, from about 435 nm to about 455 nm, or from about 445 nm to about 450 nm.

In some embodiments, transmittance valley 806T can be a saddleback transmittance valley. Transmittance valley 806T may include a first minimum 816T, a local maximum 818T, and a second minimum 820T.

In some embodiments, a minimum transmittance of the valley 806T is less than or equal to about 25%, between about 5% and about 25%, about 8% to about 15%, about 10%, about 11%, or about 12%.

In some embodiments, the second minimum 820T of valley 806T is at a wavelength from about 465 nm to about 505 nm, from about 485 nm to about 505 nm, from about 490 nm to about 505 nm, about 495 nm to about 505 nm, at about 497 nm, at about 498 nm, at about 499 nm, or at about 500 nm.

In some embodiments, local maximum 818T is at wavelength from about 475 nm to about 495 nm, from about 480 nm to about 490 nm, at about 483 nm, at about 484 nm, or at about 485 nm. In some embodiments, first minimum 816T is at wavelength from about 470 nm to about 490 nm, from about 475 nm to about 485 nm, at about 478 nm, at about 479 nm, or at about 480 nm.

In some embodiments, a minimum transmittance of the valley 808T is between about 5% to about 25%, between about 10% to about 20%, about 14%, about 15%, or about 16%.

In some embodiments, the minimum transmittance of valley 808T is at a wavelength from about 630 nm to about 680 nm, from about 650 nm to about 670 nm, about 655 nm to about 665 nm, at about 662 nm, at about 663 nm, or at about 664 nm.

Referring to FIG. 8B, in some embodiments, absorbance peak 804A can be a saddleback peak. Absorbance peak 804A can include a first maximum 810A, a local minimum 812A, and a second maximum 814A. First maximum 810A can be associated with first minimum 810T. Local maximum 812T can be associated with local minimum 812A. Second maximum 814A can be associated with second minimum 814T.

Local minimum 812A is at a wavelength from about 570 nm to about 600 nm, from about 575 nm to about 595 nm, from about 580 nm to about 590 nm, at about 581 nm, at about 582 nm, at about 583 nm, at about 584 nm, or at about 585 nm. First maximum 810A is at a wavelength from about 570 nm to about 600 nm, from about 575 nm to about 580 nm, at about 574 nm, at about 575 nm, at about 576 nm, at about 577 nm, at about 578 nm, or at about 579 nm. Second maximum 814A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 812A is from about 0.5 to about 1.5, from about 0.75 to about 1.25, or from about 0.95 to about 1.1. In some embodiments, optical density at first maximum 810A is from about 0.5 to about 1.5, from about 0.75 to about 1.25, or from about 1 to about 1.2. In some embodiments, optical density at second minimum 814A is from about 0.75 to about 1.7, from about 1 to about 1.5, or from about 1.2 to about 1.4.

In some embodiments, absorbance peak 806A can be a saddleback peak. Absorbance peak 806A can include a first maximum 816A, a local minimum 818A, and a second maximum 820A. First maximum 816A can be associated with first minimum 816T. Local maximum 818T can be associated with local minimum 818A. Second maximum 820A can be associated with second minimum 820T.

In some embodiments, absorbance peak 806A can have a maximum optical density from about 0.5 to about 1.5, from about 0.75 to about 1.25, or from about 0.95 to about 1.05.

In some embodiments, absorbance peak 808A can have a maximum optical density from about 0.5 to about 1.2, from about 0.6 to about 1.1, or from about 0.7 to about 0.9.

In some embodiments, a scotopic transmission of the lens 200 is less than or equal to about 35%, is less than about 30%, is less than about 25%, is less than about 20%, about 14%, about 15%, or about 16%.

In some embodiments, a visible light transmission (as defined by EN1836) of lens 200 is from about 5% to about 30%, from about 10% to about 20%, from about 12% to about 16%, about 13%, about 14%, or about 15%.

FIG. 9A illustrates an optical transmittance profile 900T, according to some embodiments. FIG. 9B illustrates a respective optical absorbance profile 900A, according to some embodiments. It would be understood that optical characteristics exhibited in FIGS. 9A and 9B are merely illustrative and not intended to be limiting, unless mentioned otherwise. For example, optical transmittance profile 900T can represent an optical transmittance of optical filter 104, lens 200, lens 220, or lens 240 that includes a chroma enhancement filter.

Optical transmittance profile 900T can include one or more transmittance valleys, such as valleys 904T, 906T, 908T each having a minimum transmittance in one or more spectral bands. Such transmittance valleys (e.g., valleys 904T, 906T, 908T) can filter out or attenuate undesired spectral wavelengths of light. Accordingly, optical transmittance profile 900T can provide chroma enhancement in the one or more spectral bands while maintaining a minimal desired transmission at each wavelength. Optical transmittance profile 900T can also include one or more transmittance peaks such as peak 902T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 904T, 906T, and 908T illustrated in optical transmittance profile 900T can be hereinafter represented as absorbance peaks 904A, 906A, and 908A in optical absorbance profile 900A. As such, in referring to FIG. 9B, optical absorbance profile 900A can include an absorbance peak 904A associated with valley 904T, an absorbance peak 906A associated with valley 906T, and an absorbance peak 908A associated with valley 908T.

Referring to FIG. 9A, In some embodiments, transmittance valley 904T can be a saddleback transmittance valley. Transmittance valley 904T may include a first minimum 910T, a local maximum 912T, and a second minimum 914T.

Local maximum 912T is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First minimum 910T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 914T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 912T is from about 1% to about 20%, from about 3% to about 15%, from about 5% to about 10%, about 6%, about 7%, or about 8%. In some embodiments, transmittance at first minimum 910T is greater than about 5%, greater than about 6%, between about 4% and about 8%, about 6%, about 7%, or about 8%. In some embodiments, transmittance at second minimum 914T is greater than about 1%, greater than about 2%, greater than about 3% and less than about 6%, about 3%, about 4%, or about 5%.

In some embodiments, a difference in transmittance between transmittance at first minimum 910T and transmittance at local maximum 912T is less than about 5%, less than about 4%, less than about 3%, less than about 2%, or less than about 1%. In some aspects, a difference in transmittance at local maximum 912T and transmittance at second minimum 914T is greater than about 2% and less than about 6%, about 3%, about 5%, or about 4%.

As discussed previously herein, transmittance valley 904T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 910T, second minimum 914T, local maximum 912T. For example, a difference in transmittance between a transmittance at the lower edge portion and the first minimum 910T may be between about 1% to about 16%, between about 5% to about 12%, about 7%, about 8%, or about 9%. A difference between a transmittance at the upper edge portion and second minimum 914T is between about 5% to about 25%, between about 10% to about 20%, between about 12% to about 18%, about 15%, about 16%, or about 17%.

In some embodiments, transmittance valley 904T can have a transmittance bandwidth of less than about 45 nm, less than about 40 nm, or less than about 35 nm at the minimum transmittance plus 5% (transmittance at second minimum 914T). In some embodiments, transmittance valley 904T can have a transmittance bandwidth of less than about 50 nm, less than about 45 nm, or less than about 40 nm at the minimum transmittance plus 10%.

In some embodiments, transmittance valley 908T can have a transmittance bandwidth of less than about 25 nm at minimum transmittance plus 5%.

In some embodiments, the maximum transmittance of the transmittance peak 902T is between about 5% to about 30%, between about 10% to about 25%, or about 15% to about 20%.

In some embodiments, the maximum transmittance of transmittance peak 902T is at a wavelength from about 430 nm to about 480 nm, or from about 435 nm to about 455 nm, or from about 445 nm to about 450 nm.

In some embodiments, transmittance valley 906T can be a saddleback transmittance valley. Transmittance valley 906T may include a first minimum 916T, a local maximum 918T, and a second minimum 920T.

In some embodiments, a minimum transmittance of the valley 906T is less than or equal to about 25%, between about 5% and about 15%, about 7% to about 12%, about 8%, about 9%, or about 10%.

In some embodiments, the second minimum 920T of valley 906T is at a wavelength from about 465 nm to about 505 nm, from about 485 nm to about 505 nm, from about 490 nm to about 505 nm, about 495 nm to about 505 nm, at about 497 nm, at about 498 nm, at about 499 nm, or at about 500 nm.

In some embodiments, local maximum 918T is at wavelength from about 475 nm to about 495 nm, from about 480 nm to about 490 nm, at about 483 nm, at about 484 nm, or at about 485 nm. In some embodiments, first minimum 916T is at wavelength from about 470 nm to about 490 nm, from about 475 nm to about 485 nm, at about 478 nm, at about 479 nm, or at about 480 nm.

In some embodiments, a minimum transmittance of the valley 908T is between about 5% to about 25%, between about 10% to about 20%, about 11%, about 12%, or about 13%.

In some embodiments, the minimum transmittance of valley 908T is at a wavelength from about 630 nm to about 680 nm, from about 650 nm to about 670 nm, about 655 nm to about 665 nm, at about 660 nm, at about 661 nm, at about 662 nm, or at about 663 nm.

Referring to FIG. 9B, in some embodiments, absorbance peak 904A can be a saddleback peak. Absorbance peak 904A can include a first maximum 910A, a local minimum 912A, and a second maximum 914A. First maximum 910A can be associated with first minimum 910T. Local maximum 912T can be associated with local minimum 912A. Second maximum 914A can be associated with second minimum 914T.

Local minimum 912A is at a wavelength from about 570 nm to about 600 nm, from about 575 nm to about 595 nm, from about 580 nm to about 590 nm, at about 581 nm, at about 582 nm, at about 583 nm, at about 584 nm, or at about 585 nm. First maximum 910A is at a wavelength from about 570 nm to about 600 nm, from about 575 nm to about 580 nm, at about 574 nm, at about 575 nm, at about 576 nm, at about 577 nm, at about 578 nm, or at about 579 nm. Second maximum 914A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 912A is from about 0.5 to about 1.5, from about 0.75 to about 1.3, or from about 1 to about 1.2. In some embodiments, optical density at first maximum 910A is from about 0.75 to about 1.5, from about 1 to about 1.4, or from about 1.1 to about 1.3. In some embodiments, optical density at second minimum 914A is from about 1 to about 1.9, from about 1.2 to about 1.6, or from about 1.3 to about 1.5.

In some embodiments, absorbance peak 906A can be a saddleback peak. Absorbance peak 906A can include a first maximum 916A, a local minimum 918A, and a second maximum 920A. First maximum 916A can be associated with first minimum 916T. Local maximum 918T can be associated with local minimum 918A. Second maximum 920A can be associated with second minimum 920T.

In some embodiments, absorbance peak 906A can have a maximum optical density from about 0.5 to about 1.5, from about 0.75 to about 1.25, or from about 0.95 to about 1.1.

In some embodiments, absorbance peak 908A can have a maximum optical density from about 0.5 to about 1.2, from about 0.6 to about 1.1, or from about 0.8 to about 1.

In some embodiments, a scotopic transmission of the lens 200 is less than or equal to about 30%, is less than about 25%, is less than about 20%, is less than about 15%, about 12%, about 13%, or about 14%.

In some embodiments, a visible light transmission (as defined by EN1836) of lens 200 is from about 5% to about 25%, from about 7% to about 15%, about 11%, about 12%, or about 13%.

FIG. 10A illustrates an optical transmittance profile 1000T, according to some embodiments. FIG. 10B illustrates a respective optical absorbance profile 1000A, according to some embodiments. It would be understood that optical characteristics exhibited in FIGS. 10A and 10B are merely illustrative and not intended to be limiting, unless mentioned otherwise. For example, optical transmittance profile 1000T can represent an optical transmittance of optical filter 104, lens 200, lens 220, or lens 240 that includes a chroma enhancement filter.

Optical transmittance profile 1000T can include one or more transmittance valleys, such as valleys 1004T, 1006T, 1008T each having a minimum transmittance in one or more spectral bands. Such transmittance valleys (e.g., valleys 1004T, 1006T, 1008T) can filter out or attenuate undesired spectral wavelengths of light. Accordingly, optical transmittance profile 1000T can provide chroma enhancement in the one or more spectral bands while maintaining a minimal desired transmission at each wavelength. Optical transmittance profile 700T can also include one or more transmittance peaks such as peak 1002T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1004T, 1006T, and 1008T illustrated in optical transmittance profile 1000T can be hereinafter represented as absorbance peaks 1004A, 1006A, and 1008A in optical absorbance profile 1000A. As such, in referring to FIG. 7B, optical absorbance profile 1000A can include an absorbance peak 1004A associated with valley 1004T, an absorbance peak 1006A associated with valley 1006T, and an absorbance peak 1008A associated with valley 1008T.

Referring to FIG. 10A, in some embodiments, transmittance valley 1004T can be a saddleback transmittance valley. Transmittance valley 1004T may include a first minimum 1010T, a local maximum 1012T, and a second minimum 1014T.

Local maximum 1012T is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First minimum 1010T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1014T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1012T is from about 1% to about 20%, from about 5% to about 15%, from about 6% to about 10%, about 7%, about 8%, or about 9%. In some embodiments, transmittance at first minimum 1010T is greater than about 5%, greater than about 6%, between about 5% and about 10%, about 6%, about 7%, or about 8%. In some embodiments, transmittance at second minimum 1014T is from about 2% to about 6%, about 3%, about 4%, or about 5%.

In some embodiments, a difference in transmittance between transmittance at first minimum 1010T and transmittance at local maximum 1012T is less than about 5%, less than about 4%, less than about 3%, less than about 2%, or less than about 1%. In some aspects, a difference in transmittance at local maximum 1012T and transmittance at second minimum 1014T is greater than about 2% and less than about 6%, about 2%, about 3%, or about 4%.

As discussed previously herein, transmittance valley 1004T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1010T, second minimum 1014T, local maximum 1012T. For example, a difference in transmittance between a transmittance at the lower edge portion and the first minimum 1010T may be between about 2% to about 10%, between about 4% to about 8%, or about 6%. A difference between a transmittance at the upper edge portion and second minimum 1014T is between about 10% to about 30%, between about 15% to about 25%, about 20%, about 21%, or about 22%.

In some embodiments, transmittance valley 1004T can have a transmittance bandwidth of less than about 45 nm, less than about 40 nm, or less than about 35 nm at the minimum transmittance plus 5% (transmittance at second minimum 1014T). In some embodiments, transmittance valley 1004T can have a transmittance bandwidth of less than about 50 nm, less than about 45 nm, or less than about 40 nm at the minimum transmittance plus 10%.

In some embodiments, transmittance valley 1008T can have a transmittance bandwidth of less than about 20 nm at minimum transmittance plus 5% and a transmittance bandwidth of less than about 25 nm at minimum transmittance plus 10%, respectively.

In some embodiments, the maximum transmittance of the transmittance peak 1002T is between about 5% to about 20% or between about 10% to about 15%.

In some embodiments, the maximum transmittance of transmittance peak 1002T is at a wavelength from about 430 nm to about 480 nm, from about 435 nm to about 455 nm, or from about 445 nm to about 450 nm.

In some embodiments, transmittance valley 1006T can be a saddleback transmittance valley. Transmittance valley 1006T may include a first minimum 1016T, a local maximum 1018T, and a second minimum 1020T.

In some embodiments, a minimum transmittance of the valley 1006T is less than or equal to about 25%, between about 1% and about 10%, about 2% to about 7%, about 4%, about 5%, or about 6%.

In some embodiments, second minimum 1020T of valley 1006T is at a wavelength from about 465 nm to about 505 nm, from about 485 nm to about 505 nm, from about 490 nm to about 505 nm, about 495 nm to about 505 nm, about 497 nm, at about 498 nm, at about 499 nm, or at about 500 nm.

In some embodiments, local maximum 1018T is at wavelength from about 475 nm to about 495 nm, from about 480 nm to about 490 nm, at about 483 nm, at about 484 nm, or at about 485 nm. In some embodiments, first minimum 1016T is at wavelength from about 470 nm to about 490 nm, from about 475 nm to about 485 nm, at about 478 nm, at about 479 nm, or at about 480 nm.

In some embodiments, a minimum transmittance of the valley 1008T is between about 5% to about 25%, between about 10% to about 20%, about 16%, about 17%, or about 18%.

In some embodiments, the minimum transmittance of valley 1008T is at a wavelength from about 630 nm to about 680 nm, from about 650 nm to about 670 nm, about 655 nm to about 665 nm, at about 660 nm, at about 661 nm, at about 662 nm, or at about 663 nm.

Referring to FIG. 10B, in some embodiments, absorbance peak 1004A can be a saddleback peak. Absorbance peak 1004A can include a first maximum 1010A, a local minimum 1012A, and a second maximum 1014A. First maximum 1010A can be associated with first minimum 1010T. Local maximum 1012T can be associated with local minimum 1012A. Second maximum 1014A can be associated with second minimum 1014T.

Local minimum 1012A is at a wavelength from about 570 nm to about 600 nm, from about 575 nm to about 595 nm, from about 580 nm to about 590 nm, at about 581 nm, at about 582 nm, at about 583 nm, at about 584 nm, or at about 585 nm. First maximum 1010A is at a wavelength from about 570 nm to about 600 nm, from about 575 nm to about 580 nm, at about 574 nm, at about 575 nm, at about 576 nm, at about 577 nm, at about 578 nm, or at about 579 nm. Second maximum 1014A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1012A is from about 0.5 to about 1.5, from about 0.9 to about 1.4, or from about 0.9 to about 1.2. In some embodiments, optical density at first maximum 1010A is from about 0.75 to about 1.6, from about 1 to about 1.4, or from about 1.1 to about 1.3. In some embodiments, optical density at second minimum 1014A is from about 1 to about 1.7, from about 1.1 to about 1.5, or from about 1.2 to about 1.4.

In some embodiments, absorbance peak 1006A can be a saddleback peak. Absorbance peak 1006A can include a first maximum 1016A, a local minimum 1018A, and a second maximum 1020A. First maximum 1016A can be associated with first minimum 1016T. Local maximum 1018T can be associated with local minimum 1018A. Second maximum 1020A can be associated with second minimum 1020T.

In some embodiments, absorbance peak 1006A can have a maximum optical density from about 1 to about 1.6, from about 1.1 to about 1.5, or from about 1.2 to about 1.4.

In some embodiments, absorbance peak 1008A can have a maximum optical density from about 0.5 to about 1.2, from about 0.6 to about 1.1, or from about 0.7 to about 0.9.

In some embodiments, a scotopic transmission of the lens 200 is less than or equal to about 25%, is less than about 20%, is less than about 15%, about 8%, about 9%, or about 10%.

In some embodiments, a visible light transmission (as defined by EN1836) of lens 200 is from about 5% to about 20%, from about 7% to about 15%, about 10%, about 11%, or about 12%.

FIG. 11A illustrates an optical transmittance profile 1100T, according to some embodiments. FIG. 11B illustrates a respective optical absorbance profile 1100A, according to some embodiments. It would be understood that optical characteristics exhibited in FIGS. 11A and 11B are merely illustrative and not intended to be limiting, unless mentioned otherwise. For example, optical transmittance profile 1100T can represent an optical transmittance of optical filter 104, lens 200, lens 220, or lens 240 that includes a chroma enhancement filter.

Optical transmittance profile 1100T can include one or more transmittance valleys, such as valleys 1104T, 1106T, 1108T each having a minimum transmittance in one or more spectral bands. Such transmittance valleys (e.g., valleys 1104T, 1106T, 1108T) can filter out or attenuate undesired spectral wavelengths of light. Accordingly, optical transmittance profile 1100T can provide chroma enhancement in the one or more spectral bands while maintaining a minimal desired transmission at each wavelength. Optical transmittance profile 1100T can also include one or more transmittance peaks such as peak 1102T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1104T, 1106T, and 1108T illustrated in optical transmittance profile 1100T can be hereinafter represented as absorbance peaks 1104A, 1106A, and 1108A in optical absorbance profile 1100A. As such, in referring to FIG. 11B, optical absorbance profile 1100A can include an absorbance peak 1104A associated with valley 1104T, an absorbance peak 1106A associated with valley 1106T, and an absorbance peak 1108A associated with valley 1108T.

Referring to FIG. 11A, in some embodiments, transmittance valley 1104T can be a saddleback transmittance valley. Transmittance valley 1104T may include a first minimum 1110T, a local maximum 1112T, and a second minimum 1114T.

Local maximum 1112T is at a wavelength from about 570 nm to about 600 nm, from about 575 nm to about 595 nm, from about 580 nm to about 590 nm, at about 582 nm, at about 583 nm, at about 584 nm, at about 585 nm, or at about 586 nm. First minimum 1110T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1114T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1112T is from about 1% to about 20%, from about 5% to about 15%, about 7%, about 8%, or about 9%. In some embodiments, transmittance at first minimum 1110T is from about 2% to about 10%, from about 4% to about 8%, about 5%, about 6%, or about 7%. In some embodiments, transmittance at second minimum 1114T is from about 2% to about 10%, from about 4% to about 8%, about 5%, about 6%, or about 7%.

In some embodiments, a difference in transmittance between transmittance at first minimum 1110T and transmittance at local maximum 1112T is less than about 5%, less than about 4%, less than about 3%, or less than about 2%. In some aspects, a difference in transmittance at local maximum 1112T and transmittance at second minimum 1114T is greater than about 2% and less than about 6%, about 3%, about 4%, or about 5%.

As discussed previously herein, transmittance valley 1104T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1110T, second minimum 1114T, local maximum 1112T. For example, a difference in transmittance between a transmittance at the lower edge portion and the first minimum 1110T may be from about 5% to about 25%, from about 10% to about 20%, about 15%, about 16%, or about 17%. A difference between a transmittance at the upper edge portion and second minimum 1114T is from about 10% to about 30%, from about 15% to about 25%, about 19%, about 18%, or about 17%.

In some embodiments, transmittance valley 1104T can have a transmittance bandwidth of less than about 45 nm, less than about 40 nm, or less than about 35 nm at the minimum transmittance plus 5%. In some embodiments, transmittance valley 1104T can have a transmittance bandwidth of less than about 50 nm, less than about 45 nm, or less than about 40 nm at the minimum transmittance plus 10%.

In some embodiments, transmittance valley 1108T can have a transmittance bandwidth of less than about 25 nm at minimum transmittance plus 5%.

In some embodiments, the maximum transmittance of the transmittance peak 1102T is between about 15% to about 35%, between about 20% to about 30%, or about 25% to about 30%.

In some embodiments, the maximum transmittance of transmittance peak 1102T is at a wavelength from about 430 nm to about 480 nm, or from about 435 nm to about 455 nm, or from about 445 nm to about 450 nm.

In some embodiments, transmittance valley 1106T can be a saddleback transmittance valley. Transmittance valley 1106T may include a first minimum 1116T, a local maximum 1118T, and a second minimum 1120T.

In some embodiments, a minimum transmittance of the valley 1106T is less than or equal to about 25%, from about 5% and about 15%, from about 7% to about 12%, about 9%, about 10%, or about 11%.

In some embodiments, the second minimum 1120T of valley 1106T is at a wavelength from about 465 nm to about 505 nm, from about 485 nm to about 505 nm, from about 490 nm to about 505 nm, about 495 nm to about 505 nm, at about 497 nm, at about 498 nm, at about 499 nm, or at about 500 nm.

In some embodiments, local maximum 1118T is at wavelength from about 475 nm to about 495 nm, from about 480 nm to about 490 nm, at about 483 nm, at about 484 nm, or at about 485 nm. In some embodiments, first minimum 1116T is at wavelength from about 470 nm to about 490 nm, from about 475 nm to about 485 nm, at about 478 nm, at about 479 nm, or at about 480 nm.

In some embodiments, a minimum transmittance of the valley 1108T is between about 5% to about 25%, between about 7% to about 16%, about 11%, about 12%, or about 13%.

In some embodiments, the minimum transmittance of valley 1108T is at a wavelength from about 630 nm to about 680 nm, from about 650 nm to about 670 nm, about 655 nm to about 665 nm, at about 659 nm, at about 660 nm, at about 661 nm, or at about 662 nm.

Referring to FIG. 11B, in some embodiments, absorbance peak 1104A can be a saddleback peak. Absorbance peak 1104A can include a first maximum 1110A, a local minimum 1112A, and a second maximum 1114A. First maximum 1110A can be associated with first minimum 1110T. Local maximum 1112T can be associated with local minimum 1112A. Second maximum 1114A can be associated with second minimum 1114T.

Local minimum 1112A is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First maximum 1110A is at a wavelength from about 570 nm to about 600 nm, from about 575 nm to about 580 nm, at about 577 nm, at about 578 nm, or at about 579 nm. Second maximum 1114A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1112A is from about 0.5 to about 1.5, from about 0.75 to about 1.25, or from about 1 to about 1.2. In some embodiments, optical density at first maximum 1110A is from about 1 to about 1.4, or from about 1.1 to about 1.3. In some embodiments, optical density at second minimum 1114A is from about 1 to about 1.6, from about 1.1 to about 1.5, or from about 1.2 to about 1.4.

Referring to FIG. 11B, in some embodiments, absorbance peak 1106A can be a saddleback peak. Absorbance peak 1106A can include a first maximum 1116A, a local minimum 1118A, and a second maximum 1120A. First maximum 1116A can be associated with first minimum 1116T. Local maximum 1118T can be associated with local minimum 1118A. Second maximum 1120A can be associated with second minimum 1120T.

In some embodiments, absorbance peak 1106A can have a maximum optical density from about 0.5 to about 1.5, from about 0.75 to about 1.25, or from about 0.85 to about 1.05.

In some embodiments, absorbance peak 1108A can have a maximum optical density from about 0.6 to about 1.2, from about 0.7 to about 1.1, or from about 0.8 to about 1.

In some embodiments, a scotopic transmission of the lens 200 is less than or equal to about 35%, is less than about 30%, is less than about 25%, is less than about 20%, about 16%, about 17%, or about 18%.

In some embodiments, a visible light transmission (as defined by EN1836) of lens 200 is from about 5% to about 30%, from about 10% to about 20%, about 16%, about 17%, or about 18%.

FIG. 12A illustrates an optical transmittance profile 1200T, according to some embodiments. FIG. 12B illustrates a respective optical absorbance profile 1200A, according to some embodiments. It would be understood that optical characteristics exhibited in FIGS. 12A and 12B are merely illustrative and not intended to be limiting, unless mentioned otherwise. For example, optical transmittance profile 1200T can represent an optical transmittance of optical filter 104, lens 200, lens 220, or lens 240 that includes a chroma enhancement filter.

Optical transmittance profile 1200T can include one or more transmittance valleys, such as valleys 1204T, 1206T, 1208T each having a minimum transmittance in one or more spectral bands. Such transmittance valleys (e.g., valleys 1204T, 1206T, 1208T) can filter out or attenuate undesired spectral wavelengths of light. Accordingly, optical transmittance profile 1200T can provide chroma enhancement in the one or more spectral bands while maintaining a minimal desired transmission at each wavelength. Optical transmittance profile 1200T can also include one or more transmittance peaks such as peak 1202T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1204T, 1206T, and 1208T illustrated in optical transmittance profile 1200T can be hereinafter represented as absorbance peaks 1204A, 1206A, and 1208A in optical absorbance profile 1200A. As such, in referring to FIG. 12B, optical absorbance profile 1200A can include an absorbance peak 1204A associated with valley 1204T, an absorbance peak 1206A associated with valley 1206T, and an absorbance peak 1208A associated with valley 1208T.

Referring to FIG. 12A, in some embodiments, transmittance valley 1204T can be a saddleback transmittance valley. Transmittance valley 1204T may include a first minimum 1210T, a local maximum 1212T, and a second minimum 1214T.

Local maximum 1212T is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First minimum 1210T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1214T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1212T is from about 1% to about 20%, from about 5% to about 15%, about 7%, about 8%, or about 9%. In some embodiments, transmittance at first minimum 1210T is from about 2% to about 10%, from about 4% to about 8%, about 5%, about 6%, or about 7%. In some embodiments, transmittance at second minimum 1214T is from about 2% to about 10%, from about 3% to about 8%, about 4%, about 5%, or about 6%.

In some embodiments, a difference in transmittance between transmittance at first minimum 1210T and transmittance at local maximum 1212T is less than about 5%, less than about 4%, less than about 3%, or less than about 2%. In some aspects, a difference in transmittance at local maximum 1212T and transmittance at second minimum 1214T is greater than about 2% and less than about 5%, about 2%, or about 3%.

As discussed previously herein, transmittance valley 1204T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1210T, second minimum 1214T, local maximum 1212T. For example, a difference in transmittance between a transmittance at the lower edge portion and the first minimum 1210T may be from about 5% to about 20%, from about 7% to about 15%, about 10%, about 11%, or about 12%. A difference between a transmittance at the upper edge portion and second minimum 1214T is from about 10% to about 30%, from about 15% to about 25%, about 19%, about 20%, or about 21%.

In some embodiments, transmittance valley 1204T can have a transmittance bandwidth of less than about 45 nm, less than about 40 nm, or less than about 35 nm at the minimum transmittance plus 5%. In some embodiments, transmittance valley 1204T can have a transmittance bandwidth of less than about 50 nm, less than about 45 nm, or less than about 40 nm at the minimum transmittance plus 10%.

In some embodiments, transmittance valley 1208T can have a transmittance bandwidth of less than about 25 nm at minimum transmittance plus 5%.

In some embodiments, the maximum transmittance of the transmittance peak 1202T is between about 15% to about 40%, between about 20% to about 35%, or between about 25% to about 30%.

In some embodiments, the maximum transmittance of transmittance peak 1202T is at a wavelength from about 430 nm to about 480 nm, or from about 435 nm to about 455 nm, or from about 445 nm to about 450 nm.

In some embodiments, transmittance valley 1206T can be a saddleback transmittance valley. Transmittance valley 1206T may include a first minimum 1216T, a local maximum 1218T, and a second minimum 1220T.

In some embodiments, a minimum transmittance of the valley 1206T is less than or equal to about 25%, from about 2% and about 9%, from about 3% to about 8%, about 7%, about 8%, or about 9%.

In some embodiments, second minimum 1220T of valley 1206T is at a wavelength from about 465 nm to about 505 nm, from about 485 nm to about 505 nm, from about 490 nm to about 505 nm, about 495 nm to about 505 nm, at about 496 nm, at about 497 nm, at about 498 nm, or at about 499 nm.

In some embodiments, local maximum 1218T is at wavelength from about 475 nm to about 495 nm, from about 480 nm to about 490 nm, at about 483 nm, at about 484 nm, or at about 485 nm. In some embodiments, first minimum 1216T is at wavelength from about 470 nm to about 490 nm, from about 475 nm to about 485 nm, at about 478 nm, at about 479 nm, or at about 480 nm.

In some embodiments, a minimum transmittance of the valley 1208T is between about 5% to about 25%, between about 7% to about 16%, about 10%, about 11%, or about 12%.

In some embodiments, the minimum transmittance of valley 1208T is at a wavelength from about 630 nm to about 680 nm, from about 650 nm to about 670 nm, about 655 nm to about 665 nm, at about 659 nm, at about 661 nm, at about 662 nm, or at about 663 nm.

Referring to FIG. 12B, in some embodiments, absorbance peak 1204A can be a saddleback peak. Absorbance peak 1204A can include a first maximum 1210A, a local minimum 1212A, and a second maximum 1214A. First maximum 1210A can be associated with first minimum 1210T. Local maximum 1212T can be associated with local minimum 1212A. Second maximum 1214A can be associated with second minimum 1214T.

Local minimum 1212A is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First maximum 1210A is at a wavelength from about 570 nm to about 600 nm, from about 575 nm to about 580 nm, at about 577 nm, at about 578 nm, or at about 579 nm. Second maximum 1214A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1212A is from about 0.5 to about 1.5, from about 0.75 to about 1.25, or from about 1 to about 1.2. In some embodiments, optical density at first maximum 1210A is from about 1 to about 1.4, or from about 1.1 to about 1.3. In some embodiments, optical density at second minimum 1214A is from about 1 to about 1.4, or from about 1.1 to about 1.3.

In some embodiments, absorbance peak 1206A can be a saddleback peak. Absorbance peak 1206A can include a first maximum 1216A, a local minimum 1218A, and a second maximum 1220A. First maximum 1216A can be associated with first minimum 1216T. Local maximum 1218T can be associated with local minimum 1218A. Second maximum 1220A can be associated with second minimum 1220T.

In some embodiments, absorbance peak 1206A can have a maximum optical density from about 0.5 to about 1.5, from about 0.75 to about 1.25, or from about 0.85 to about 1.05.

In some embodiments, absorbance peak 1208A can have a maximum optical density from about 0.8 to about 1.2 or from about 0.9 to about 1.1.

In some embodiments, a scotopic transmission of the lens 200 is less than or equal to about 35%, is less than about 30%, is less than about 25%, is less than about 20%, about 13%, about 14%, or about 15%.

In some embodiments, a visible light transmission (as defined by EN1836) of lens 200 is from about 5% to about 30%, from about 10% to about 20%, about 13%, about 14%, or about 15%.

FIG. 13A illustrates an optical transmittance profile 1300T, according to some embodiments. FIG. 13B illustrates a respective optical absorbance profile 1300A, according to some embodiments. It would be understood that optical characteristics exhibited in FIGS. 13A and 13B are merely illustrative and not intended to be limiting, unless mentioned otherwise. For example, optical transmittance profile 1300T can represent an optical transmittance of optical filter 104, lens 200, lens 220, or lens 240 that includes a chroma enhancement filter.

Optical transmittance profile 1300T can include one or more transmittance valleys, such as valleys 1304T, 1306T, 1308T each having a minimum transmittance in one or more spectral bands. Such transmittance valleys (e.g., valleys 1304T, 1306T, 1308T) can filter out or attenuate undesired spectral wavelengths of light. Accordingly, optical transmittance profile 1300T can provide chroma enhancement in the one or more spectral bands while maintaining a minimal desired transmission at each wavelength. Optical transmittance profile 1300T can also include one or more transmittance peaks such as peak 1302T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1304T, 1306T, and 1308T illustrated in optical transmittance profile 1300T can be hereinafter represented as absorbance peaks 1304A, 1306A, and 1308A in optical absorbance profile 1300A. As such, in referring to FIG. 13B, optical absorbance profile 1300A can include an absorbance peak 1304A associated with valley 1304T, an absorbance peak 1306A associated with valley 1306T, and an absorbance peak 1308A associated with valley 1308T.

Referring to FIG. 13A, in some embodiments, transmittance valley 1304T can be a saddleback transmittance valley. Transmittance valley 1304T may include a first minimum 1310T, a local maximum 1312T, and a second minimum 1314T.

Local maximum 1312T is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First minimum 1310T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1314T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1312T is from about 1% to about 20%, from about 5% to about 15%, about 5%, about 6%, or about 7%. In some embodiments, transmittance at first minimum 1310T is from about 2% to about 10%, from about 3% to about 8%, about 4%, about 5%, or about 6%. In some embodiments, transmittance at second minimum 1314T is from about 2% to about 10%, from about 3% to about 8%, about 4%, about 5%, or about 6%.

In some embodiments, a difference in transmittance between transmittance at first minimum 1310T and transmittance at local maximum 1312T is less than about 5%, less than about 4%, less than about 3%, or less than about 2%. In some aspects, a difference in transmittance at local maximum 1312T and transmittance at second minimum 1314T is less than about 5%, less than about 4%, less than about 3%, or less than about 2%.

As discussed previously herein, transmittance valley 1304T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1310T, second minimum 1314T, local maximum 1312T. For example, a difference in transmittance between a transmittance at the lower edge portion and the first minimum 1310T may be from about 5% to about 20%, from about 7% to about 15%, about 10%, about 11%, or about 12%. A difference between a transmittance at the upper edge portion and second minimum 1314T is from about 5% to about 25%, from about 10% to about 20%, about 14%, about 15%, or about 16%.

In some embodiments, transmittance valley 1304T can have a transmittance bandwidth of less than about 45 nm, less than about 40 nm, or less than about 35 nm at the minimum transmittance plus 5%. In some embodiments, transmittance valley 1304T can have a transmittance bandwidth of less than about 50 nm, less than about 45 nm, or less than about 40 nm at the minimum transmittance plus 10%.

In some embodiments, transmittance valley 1308T can have a transmittance bandwidth of less than about 25 nm at minimum transmittance plus 5%.

In some embodiments, the maximum transmittance of the transmittance peak 1302T is between about 10% to about 30%, between about 15% to about 25%, or about 15% to about 20%.

In some embodiments, the maximum transmittance of transmittance peak 1302T is at a wavelength from about 430 nm to about 480 nm, from about 435 nm to about 455 nm, or from about 445 nm to about 450 nm.

In some embodiments, transmittance valley 1306T can be a saddleback transmittance valley. Transmittance valley 1306T may include a first minimum 1316T, a local maximum 1318T, and a second minimum 1320T.

In some embodiments, a minimum transmittance of the valley 1306T is less than or equal to about 25%, from about 2% and about 10%, from about 3% to about 9%, about 6%, about 7%, or about 8%.

In some embodiments, second minimum 1320T of valley 1306T is at a wavelength from about 465 nm to about 505 nm, from about 485 nm to about 505 nm, from about 490 nm to about 505 nm, from about 495 nm to about 505 nm, at about 496 nm, at about 497 nm, at about 498 nm, or at about 499 nm.

In some embodiments, local maximum 1318T is at wavelength from about 475 nm to about 495 nm, from about 480 nm to about 490 nm, at about 483 nm, at about 484 nm, or at about 485 nm. In some embodiments, first minimum 1316T is at wavelength from about 470 nm to about 490 nm, from about 475 nm to about 485 nm, at about 478 nm, at about 479 nm, or at about 480 nm.

In some embodiments, a minimum transmittance of the valley 1308T is between about 1% to about 20%, between about 5% to about 10%, about 7%, about 8%, or about 9%.

In some embodiments, the minimum transmittance of valley 1308T is at a wavelength from about 630 nm to about 680 nm, from about 650 nm to about 670 nm, about 655 nm to about 665 nm, at about 659 nm, at about 660 nm, at about 661 nm, at about 662 nm, or at about 663 nm.

Referring to FIG. 13A, in some embodiments, absorbance peak 1304A can be a saddleback peak. Absorbance peak 1304A can include a first maximum 1310A, a local minimum 1312A, and a second maximum 1314A. First maximum 1310A can be associated with first minimum 1310T. Local maximum 1312T can be associated with local minimum 1312A. Second maximum 1314A can be associated with second minimum 1314T.

Local minimum 1312A is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First maximum 1310A is at a wavelength from about 570 nm to about 600 nm, from about 575 nm to about 580 nm, at about 577 nm, at about 578 nm, or at about 579 nm. Second maximum 1314A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1312A is from about 0.75 to about 1.85, from about 1 to about 1.5, or from about 1.1 to about 1.3. In some embodiments, optical density at first maximum 1310A is from about 1 to about 1.6, or from about 1.2 to about 1.4. In some embodiments, optical density at second minimum 1314A is from about 1 to about 1.6 or from about 1.2 to about 1.4.

In some embodiments, absorbance peak 1306A can be a saddleback peak. Absorbance peak 1306A can include a first maximum 1316A, a local minimum 1318A, and a second maximum 1320A. First maximum 1316A can be associated with first minimum 1316T. Local maximum 1318T can be associated with local minimum 1318A. Second maximum 1320A can be associated with second minimum 1320T.

In some embodiments, absorbance peak 1306A can have a maximum optical density from about 0.5 to about 1.5, from about 0.75 to about 1.25, or from about 0.95 to about 1.15.

In some embodiments, absorbance peak 1308A can have a maximum optical density from about 0.8 to about 1.2 or from about 0.9 to about 1.1.

In some embodiments, a scotopic transmission of the lens 200 is less than or equal to about 35%, is less than about 30%, is less than about 25%, is less than about 20%, about 11%, about 12%, or about 13%.

In some embodiments, a visible light transmission (as defined by EN1836) of lens 200 is from about 5% to about 30%, from about 10% to about 20%, about 11%, about 12%, or about 13%.

FIG. 14A illustrates an optical transmittance profile 1400T, according to some embodiments. FIG. 14B illustrates a respective optical absorbance profile 1400A, according to some embodiments. It would be understood that optical characteristics exhibited in FIGS. 14A and 14B are merely illustrative and not intended to be limiting, unless mentioned otherwise. For example, optical transmittance profile 1400T can represent an optical transmittance of optical filter 104, lens 200, lens 220, or lens 240 that includes a chroma enhancement filter.

Optical transmittance profile 1400T can include one or more transmittance valleys, such as valleys 1404T, 1406T, 1408T each having a minimum transmittance in one or more spectral bands. Such transmittance valleys (e.g., valleys 1404T, 1406T, 1408T) can filter out or attenuate undesired spectral wavelengths of light. Accordingly, optical transmittance profile 1400T can provide chroma enhancement in the one or more spectral bands while maintaining a minimal desired transmission at each wavelength. Optical transmittance profile 1400T can also include one or more transmittance peaks such as peak 1402T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1404T, 1406T, and 1408T illustrated in optical transmittance profile 1400T can be hereinafter represented as absorbance peaks 1404A, 1406A, and 1408A in optical absorbance profile 1400A. As such, in referring to FIG. 14B, optical absorbance profile 1400A can include an absorbance peak 1404A associated with valley 1404T, an absorbance peak 1406A associated with valley 1406T, and an absorbance peak 1408A associated with valley 1408T.

Referring to FIG. 14A, in some embodiments, transmittance valley 1404T can be a saddleback transmittance valley. Transmittance valley 1404T may include a first minimum 1410T, a local maximum 1412T, and a second minimum 1414T.

Local maximum 1412T is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First minimum 1410T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1414T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1412T is from about 1% to about 20%, from about 5% to about 15%, about 6%, about 7%, or about 8%. In some embodiments, transmittance at first minimum 1410T is substantially equal to the transmittance at second minimum 1414T. In some embodiments, transmittance at first minimum 1410T is from about 2% to about 10%, from about 3% to about 8%, about 4%, about 5%, or about 6%. In some embodiments, transmittance at second minimum 1414T is from about 2% to about 10%, from about 3% to about 8%, about 4%, about 5%, or about 6%.

In some embodiments, a difference in transmittance between transmittance at first minimum 1410T and transmittance at local maximum 1412T is less than about 5%, less than about 4%, less than about 3%, or less than about 2%. In some aspects, a difference in transmittance at local maximum 1412T and transmittance at second minimum 1414T is less than about 5%, less than about 4%, less than about 3%, or less than about 2%.

As discussed previously herein, transmittance valley 1404T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1410T, second minimum 1414T, local maximum 1412T. For example, a difference in transmittance between a transmittance at the lower edge portion and the first minimum 1410T may be from about 5% to about 20%, from about 7% to about 15%, about 8%, about 9%, or about 10%. A difference between a transmittance at the upper edge portion and second minimum 1314T is from about 5% to about 25%, from about 15% to about 25%, about 20%, about 21%, or about 22%.

In some embodiments, transmittance valley 1404T can have a transmittance bandwidth of less than about 45 nm, less than about 40 nm, or less than about 35 nm at the minimum transmittance plus 5% (transmittance at second minimum 1414T). In some embodiments, transmittance valley 1404T can have a transmittance bandwidth of less than about 50 nm, less than about 45 nm, or less than about 40 nm at the minimum transmittance plus 10%.

In some embodiments, transmittance valley 1408T can have a transmittance bandwidth of less than about 25 nm at minimum transmittance plus 5%.

In some embodiments, the maximum transmittance of the transmittance peak 1402T is from about 5% to about 20% or from about 10% to about 15%.

In some embodiments, the maximum transmittance of transmittance peak 1402T is at a wavelength from about 430 nm to about 480 nm, from about 435 nm to about 455 nm, or from about 445 nm to about 450 nm.

In some embodiments, transmittance valley 1406T can be a saddleback transmittance valley. Transmittance valley 1406T may include a first minimum 1416T, a local maximum 1418T, and a second minimum 1420T.

In some embodiments, a minimum transmittance of the valley 1406T is less than or equal to about 25%, from about 2% and about 10%, from about 3% to about 9%, about 4%, about 5%, or about 6%.

In some embodiments, second minimum 1420T of valley 1406T is at a wavelength from about 465 nm to about 505 nm, from about 485 nm to about 505 nm, from about 490 nm to about 505 nm, about 495 nm to about 505 nm, at about 496 nm, at about 497 nm, at about 498 nm, or at about 499 nm. In some embodiments, local maximum 1418T is at wavelength from about 475 nm to about 495 nm, from about 480 nm to about 490 nm, at about 483 nm, at about 484 nm, or at about 485 nm. In some embodiments, first minimum 1416T is at wavelength from about 470 nm to about 490 nm, from about 475 nm to about 485 nm, at about 478 nm, at about 479 nm, or at about 480 nm.

In some embodiments, a minimum transmittance of the valley 1408T is between about 1% to about 20%, between about 5% to about 15%, about 11%, about 12%, or about 13%.

In some embodiments, the minimum transmittance of valley 1408T is at a wavelength from about 630 nm to about 680 nm, from about 650 nm to about 670 nm, about 655 nm to about 665 nm, at about 659 nm, at about 660 nm, at about 661 nm, at about 662 nm, or at about 663 nm.

Referring to FIG. 14B, in some embodiments, absorbance peak 1404A can be a saddleback peak. Absorbance peak 1404A can include a first maximum 1410A, a local minimum 1412A, and a second maximum 1414A. First maximum 1410A can be associated with first minimum 1410T. Local maximum 1412T can be associated with local minimum 1412A. Second maximum 1414A can be associated with second minimum 1414T.

Local minimum 1412A is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First maximum 1410A is at a wavelength from about 570 nm to about 600 nm, from about 575 nm to about 580 nm, about 577 nm, about 578 nm, or at about 579 nm. Second maximum 1414A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1412A is from about 0.75 to about 1.85, from about 1 to about 1.5, or from about 1.1 to about 1.3. In some embodiments, optical density at first maximum 1410A is from about 1 to about 1.6, or from about 1.2 to about 1.4. In some embodiments, optical density at second minimum 1414A is from about 1 to about 1.6 or from about 1.2 to about 1.4.

In some embodiments, absorbance peak 1406A can be a saddleback peak. Absorbance peak 1406A can include a first maximum 1416A, a local minimum 1418A, and a second maximum 1420A. First maximum 1416A can be associated with first minimum 1416T. Local maximum 1418T can be associated with local minimum 1418A. Second maximum 1420A can be associated with second minimum 1420T.

In some embodiments, absorbance peak 1406A can have a maximum optical density from about 0.75 to about 1.75, from about 1 to about 1.55, or from about 1.25 to about 1.45.

In some embodiments, absorbance peak 1408A can have a maximum optical density from about 0.7 to about 1.2 or from about 0.8 to about 1.1.

In some embodiments, a scotopic transmission of the lens 200 is less than or equal to about 35%, is less than about 30%, is less than about 25%, is less than about 20%, about 8%, about 9%, or about 10%.

In some embodiments, a visible light transmission (as defined by EN1836) of lens 200 is from about 5% to about 30%, from about 10% to about 20%, about 10%, about 11%, or about 12%.

FIG. 15A illustrates an optical transmittance profile 1500T, according to some embodiments. FIG. 15B illustrates a respective optical absorbance profile 1500A, according to some embodiments. It would be understood that optical characteristics exhibited in FIGS. 15A and 15B are merely illustrative and not intended to be limiting, unless mentioned otherwise. For example, optical transmittance profile 1500T can represent an optical transmittance of optical filter 104, lens 200, lens 220, or lens 240 that includes a chroma enhancement filter.

Optical transmittance profile 1500T can include one or more transmittance valleys, such as valleys 1504T, 1508T each having a minimum transmittance in one or more spectral bands. Such transmittance valleys (e.g., valleys 1504T, 1508T) can filter out or attenuate undesired spectral wavelengths of light. Accordingly, optical transmittance profile 1500T can provide chroma enhancement in the one or more spectral bands while maintaining a minimal desired transmission at each wavelength. Optical transmittance profile 1500T can also include one or more transmittance peaks such as peak 1502T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1504T and 1508T illustrated in optical transmittance profile 1500T can be hereinafter represented as absorbance peaks 1504A and 1508A in optical absorbance profile 1500A. As such, in referring to FIG. 15B, optical absorbance profile 1500A can include an absorbance peak 1504A associated with valley 1504T, and an absorbance peak 1508A associated with valley 1508T.

Referring to FIG. 15A, in some embodiments, transmittance valley 1504T can be a saddleback transmittance valley. Transmittance valley 1504T may include a first minimum 1510T, a local maximum 1512T, and a second minimum 1514T.

Local maximum 1512T is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First minimum 1510T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1514T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1512T is from about 1% to about 20%, from about 5% to about 15%, about 7%, about 8%, or about 9%. In some embodiments, transmittance at first minimum 1510T is from about 2% to about 12%, from about 3% to about 8%, about 5%, about 6%, or about 7%. In some embodiments, transmittance at second minimum 1514T is from about 2% to about 12%, from about 3% to about 8%, about 5%, about 6%, or about 7%.

In some embodiments, a difference in transmittance between transmittance at first minimum 1510T and transmittance at local maximum 1512T is less than about 5%, less than about 4%, or less than about 3%. In some aspects, a difference in transmittance at local maximum 1512T and transmittance at second minimum 1514T is less than about 5%, less than about 4%, or less than about 3%.

As discussed previously herein, transmittance valley 1504T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1510T, second minimum 1514T, local maximum 1512T. For example, a difference in transmittance between a transmittance at the lower edge portion and the first minimum 1510T may be from about 5% to about 15%, from about 7% to about 12%, about 8%, about 9%, or about 10%. A difference between a transmittance at the upper edge portion and second minimum 1314T is from about 10% to about 30%, from about 15% to about 25%, about 19%, about 20%, or about 21%.

In some embodiments, transmittance valley 1504T can have a transmittance bandwidth of less than about 45 nm, less than about 40 nm, or less than about 35 nm at the minimum transmittance plus 5% (transmittance at first minimum 1510T). In some embodiments, transmittance valley 1504T can have a transmittance bandwidth of less than about 50 nm, less than about 45 nm, or less than about 40 nm at the minimum transmittance plus 10%.

In some embodiments, transmittance valley 1508T can have a transmittance bandwidth of less than about 25 nm, less than about 20 nm, or less than about 15 nm at minimum transmittance plus 5%.

In some embodiments, the maximum transmittance of the transmittance peak 1502T is from about 15% to about 35%, from about 20% to about 30%, or from about 22% to about 27%.

In some embodiments, the maximum transmittance of transmittance peak 1502T is at a wavelength from about 440 nm to about 510 nm or from about 460 nm to about 500 nm.

In some embodiments, a minimum transmittance of the valley 1508T is between about 10% to about 30%, between about 15% to about 25%, about 18%, about 19%, or about 20%.

In some embodiments, the minimum transmittance of valley 1508T is at a wavelength from about 630 nm to about 680 nm, from about 650 nm to about 670 nm, from about 655 nm to about 665 nm, at about 659 nm, at about 660 nm, at about 661 nm, at about 662 nm, or at about 663 nm.

Referring to FIG. 15B, in some embodiments, absorbance peak 1504A can be a saddleback peak. Absorbance peak 1504A can include a first maximum 1510A, a local minimum 1512A, and a second maximum 1514A. First maximum 1510A can be associated with first minimum 1510T. Local maximum 1512T can be associated with local minimum 1512A. Second maximum 1514A can be associated with second minimum 1514T.

Local minimum 1512A is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First maximum 1510A is at a wavelength from about 570 nm to about 600 nm, from about 575 nm to about 580 nm, at about 577 nm, at about 578 nm, or at about 579 nm. Second maximum 1514A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1512A is from about 0.5 to about 1.5, from about 0.75 to about 1.25, or from about 0.9 to about 1.1. In some embodiments, optical density at first maximum 1510A is from about 0.9 to about 1.6, or from about 1.1 to about 1.4. In some embodiments, optical density at second minimum 1514A is from about 0.9 to about 1.6, or from about 1.1 to about 1.4.

In some embodiments, absorbance peak 1508A can have a maximum optical density from about 0.3 to about 1.2 or from about 0.5 to about 1.

In some embodiments, a scotopic transmission of the lens 200 is less than or equal to about 35%, is less than about 30%, is less than about 25%, is less than about 20%, about 17%, about 18%, or about 19%.

In some embodiments, a visible light transmission (as defined by EN1836) of lens 200 is from about 5% to about 25%, from about 10% to about 20%, about 14%, about 15%, or about 16%.

FIG. 16A illustrates an optical transmittance profile 1600T, according to some embodiments. FIG. 16B illustrates a respective optical absorbance profile 1600A, according to some embodiments. It would be understood that optical characteristics exhibited in FIGS. 16A and 16B are merely illustrative and not intended to be limiting, unless mentioned otherwise. For example, optical transmittance profile 1600T can represent an optical transmittance of optical filter 104, lens 200, lens 220, or lens 240 that includes a chroma enhancement filter.

Optical transmittance profile 1600T can include one or more transmittance valleys, such as valleys 1604T, 1606T, 1608T each having a minimum transmittance in one or more spectral bands. Such transmittance valleys (e.g., valleys 1604T, 1606T, 1608T) can filter out or attenuate undesired spectral wavelengths of light. Accordingly, optical transmittance profile 1600T can provide chroma enhancement in the one or more spectral bands while maintaining a minimal desired transmission at each wavelength. Optical transmittance profile 1600T can also include one or more transmittance peaks such as peak 1602T.

In some embodiments, the optical transmittance valley and the respective absorbance peak can be positioned at about the same wavelength. Accordingly, each of the transmittance valleys in a spectrum can be regarded as an absorbance peak in the spectrum. For example, each of valleys 1604T, 1606T, and 1608T illustrated in optical transmittance profile 1600T can be hereinafter represented as absorbance peaks 1604A, 1606A, and 1608A in optical absorbance profile 1600A. As such, in referring to FIG. 16B, optical absorbance profile 1600A can include an absorbance peak 1604A associated with valley 1604T, an absorbance peak 1606A associated with valley 1606T, and an absorbance peak 1608A associated with valley 1608T.

Referring to FIG. 16A, in some embodiments, transmittance valley 1604T can be a saddleback transmittance valley. Transmittance valley 1604T may include a first minimum 1610T, a local maximum 1612T, and a second minimum 1614T.

Local maximum 1612T is at a wavelength from about 570 nm to about 600 nm, from about 575 nm to about 595 nm, from about 580 nm to about 590 nm, at about 584 nm, at about 585 nm, at about 586 nm, at about 587 nm, or at about 588 nm. First minimum 1610T is at a wavelength from about 570 nm to about 600 nm, from about 575 nm to about 580 nm, at about 575 nm, at about 576 nm, at about 577 nm, at about 578 nm, at about 579 nm, or at about 580 nm. Second minimum 1614T is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, transmittance at local maximum 1612T is from about 1% to about 20%, from about 5% to about 15%, about 7%, about 8%, or about 9%. In some embodiments, transmittance at first minimum 1610T is substantially equal to the transmittance at second minimum 1614T. In some embodiments, transmittance at first minimum 1610T is from about 2% to about 10%, from about 3% to about 8%, about 4%, about 5%, or about 6%. In some embodiments, transmittance at second minimum 1614T is from about 2% to about 10%, from about 3% to about 8%, about 5%, about 6%, or about 7%.

In some embodiments, a difference in transmittance between transmittance at first minimum 1610T and transmittance at local maximum 1612T is less than about 5%, less than about 4%, or less than about 3%. In some aspects, a difference in transmittance at local maximum 1612T and transmittance at second minimum 1614T is less than about 5%, less than about 4%, or less than about 3%.

As discussed previously herein, transmittance valley 1604T can be between a lower edge portion (e.g., closer to about 565 nm) and a upper edge portion (e.g., closer to about 610 nm) of the spectral band (e.g., between about 570 nm and about 600 nm). Transmittance at the lower edge portion and the upper edge portion can be greater than that of first minimum 1610T, second minimum 1614T, local maximum 1612T. For example, a difference in transmittance between a transmittance at the lower edge portion and the first minimum 1610T may be from about 5% to about 20%, from about 7% to about 15%, about 7%, about 8%, or about 9%. A difference between a transmittance at the upper edge portion and second minimum 1614T is from about 10% to about 25%, from about 15% to about 20%, about 16%, about 17%, or about 18%.

In some embodiments, transmittance valley 1604T can have a transmittance bandwidth of less than about 45 nm, less than about 40 nm, or less than about 35 nm at the minimum transmittance plus 5% (transmittance at first minimum 1610T). In some embodiments, transmittance valley 1604T can have a transmittance bandwidth of less than about 50 nm, less than about 45 nm, or less than about 40 nm at the minimum transmittance plus 10%.

In some embodiments, transmittance valley 1608T can have a transmittance bandwidth of less than about 25 nm at minimum transmittance plus 5% and a transmittance bandwidth of less than about 25 nm at minimum transmittance plus 10%, respectively.

In some embodiments, transmittance valley 1606T can have a transmittance bandwidth of less than about 25 nm, or less than about 35 nm at minimum transmittance plus 5% or the minimum transmittance plus 10%, respectively.

In some embodiments, the maximum transmittance of the transmittance peak 1602T is from about 10% to about 30% or from about 15% to about 25%.

In some embodiments, the maximum transmittance of transmittance peak 1602T is at a wavelength from about 430 nm to about 480 nm, or from about 435 nm to about 455 nm, or from about 445 nm to about 450 nm.

In some embodiments, a minimum transmittance of the valley 1606T is less than or equal to about 25%, from about 1% and about 15%, from about 5% to about 10%, about 6%, about 7%, or about 8%.

In some embodiments, the minimum transmittance of valley 1606T is at a wavelength from about 470 nm to about 490 nm, from about 475 nm to about 485 nm, at about 480 nm, at about 481 nm, at about 482 nm, or at about 483 nm.

In some embodiments, a minimum transmittance of the valley 1608T is between about from about 5% and about 25%, from about 10% to about 20%, about 14%, about 15%, or about 16%.

In some embodiments, the minimum transmittance of valley 1608T is at a wavelength from about 630 nm to about 680 nm, from about 650 nm to about 670 nm, from about 655 nm to about 665 nm, at about 659 nm, at about 660 nm, at about 661 nm, at about 662 nm, or about 663 nm.

Referring to FIG. 16B, in some embodiments, absorbance peak 1604A can be a saddleback peak. Absorbance peak 1604A can include a first maximum 1610A, a local minimum 1612A, and a second maximum 1614A. First maximum 1610A can be associated with first minimum 1610T. Local maximum 1612T can be associated with local minimum 1612A. Second maximum 1614A can be associated with second minimum 1614T.

Local minimum 1612A is at a wavelength from about 570 nm to about 600 nm, from about 575 nm to about 595 nm, from about 580 nm to about 590 nm, about 584 nm, about 585 nm, about 586 nm, about 587 nm, or about 588 nm. First maximum 1610A is at a wavelength from about 570 nm to about 600 nm, from about 575 nm to about 580 nm, at about 577 nm, at about 578 nm, or at about 579 nm. Second maximum 1614A is at a wavelength from about 580 nm to about 600 nm, from about 590 nm to about 600 nm, from about 592 nm to about 598 nm, at about 593 nm, at about 594 nm, at about 595 nm, at about 596 nm, or at about 597 nm.

In some embodiments, optical density at local minimum 1612A is from about 0.5 to about 1.5, from about 0.75 to about 1.25, or from about 0.9 to about 1.1. In some embodiments, optical density at first maximum 1610A is from about 0.8 to about 1.6, or from about 1 to about 1.4. In some embodiments, optical density at second minimum 1614A is from about 0.8 to about 1.6 or from about 1 to about 1.4.

In some embodiments, absorbance peak 1606A can have a maximum optical density from about 0.8 to about 1.4, from about 0.9 to about 1.3, or from about 1 to about 1.2.

In some embodiments, absorbance peak 1608A can have a maximum optical density from about 0.4 to about 1.2 or from about 0.6 to about 1.

In some embodiments, a scotopic transmission of the lens 200 is less than or equal to about 35%, is less than about 30%, is less than about 25%, is less than about 20%, about 15%, about 16%, or about 17%.

In some embodiments, a visible light transmission (as defined by EN1836) of lens 200 is from about 5% to about 30%, from about 10% to about 20%, about 14%, about 15%, or about 16%.

In some embodiments, the lens (e.g., lens 200) can have an overall color appearance that may not be grey/neutral. For example, a yellowness index YI E313 of the lens 200 may be greater than about 5 or greater than about 10.

FIG. 17A illustrates an optical transmittance profile 1700T, according to some embodiments. FIG. 17B illustrates a respective optical absorbance profile 1700A, according to some embodiments. It would be understood that optical characteristics exhibited in FIGS. 17A and 17B are merely illustrative and not intended to be limiting, unless mentioned otherwise. For example, optical transmittance profile 1700T can represent an optical transmittance of optical filter 104, lens 200, lens 220, or lens 240 that includes a chroma enhancement filter.

Optical transmittance profile 1700T can include one or more transmittance valleys, such as valleys 1704T each having a minimum transmittance in one or more spectral bands. Such transmittance valleys (e.g., valleys 1704T) can filter out or attenuate undesired spectral wavelengths of light. Accordingly, optical transmittance profile 1700T can provide chroma enhancement in the one or more spectral bands while high transmission. Optical transmittance profile 1700T can also include one or more transmittance peaks such as peak

In some embodiments, the optical transmittance valley and the respective absorbance peak can be positioned at about the same wavelength. Accordingly, each of the transmittance valleys in a spectrum can be regarded as an absorbance peak in the spectrum. For example, valley 1704T illustrated in optical transmittance profile 1700T can be hereinafter represented as absorbance peak 1704A in optical absorbance profile 1700A. As such, in referring to FIG. 17B, optical absorbance profile 1700A can include an absorbance peak 1704A associated with valley 1704T. Optical absorbance profile 1700A may also include absorbance peak 1702A.

Referring to FIG. 17A, in some embodiments, transmittance valley 1704T can have a minimum transmittance at a wavelength from about 500 nm to about 650 nm, from about 525 nm to about 620 nm, from about 550 nm to about 600 nm, from about 560 to about 600, from about 565 nm to about 595 nm, from about 565 nm to about 590 nm, from about 570 nm to about 585 nm, from about 570 nm to about 580 nm.

In some embodiments, the minimum transmittance is from about 1% to about 10%, from about 1% to about 8%, from about 1% to about 6%, from about 1% to about 5%, or from about 2% to about 4%.

As discussed previously herein, transmittance valley 1704T can be between a lower edge portion (e.g., closer to about 485 nm) and a upper edge portion (e.g., closer to about 600 nm) of the spectral band (e.g., between about 490 nm and about 595 nm). Transmittance at the lower edge portion and the upper edge portion can be greater than that a minimum transmittance of transmittance valley 1704T. For example, a difference in transmittance between a transmittance at the lower edge portion and the minimum transmittance may be from about 40% to about 80%, from about 50% to about 70%, from about 55% to about 65%. A difference between a transmittance at the upper edge portion and the minimum transmittance is from about 60% to about 100%, from about 70% to about 90%, from about 75% to about 85%

In some embodiments, transmittance valley 1704T can have a transmittance bandwidth of less than about 15 nm, less than about 20 nm, less than about 25 nm, less than about 30 nm, less than about 70 nm, less than about 80 nm, or less than about 100 nm at minimum transmittance plus 5%, the minimum transmittance plus 10%, the minimum transmittance plus 15%, the minimum transmittance plus 25%, the minimum transmittance plus 35%, the minimum transmittance plus 45%, or the minimum transmittance plus 55%, respectively.

In some embodiments, the maximum transmittance of the transmittance peak 1702T is from about 40% to about 80%, from about 50% to about 70%, or from about 55% to about 65%, or from about 60% to about 65%.

In some embodiments, the maximum transmittance of transmittance peak 1702T is at a wavelength from about 430 nm to about 480 nm, from about 440 nm to about 470 nm, or from about 455 nm to about 465 nm.

Referring to FIG. 17B, in some embodiments, absorbance peak 1704A can have a maximum optical density from about 0.5 to about 2.5, from about 1 to about 2, from about 1.2 to about 1.9, or from about 1.5 to about 1.7.

In some embodiments, absorbance peak 1702A can have a maximum optical density from about 0.5 to about 2.5, from about 1 to about 2.25, from about 1.5 to about 2, or from about 1.6 to about 1.8. Maximum optical density of absorbance peak 1702A may be at a wavelength from about 395 nm to about 445 nm, from about 405 nm to about 435 nm, or from about 415 nm to about 425 nm.

In some embodiments, a scotopic transmission of the lens 200 is greater than or equal to about 35%, is from about 35% to about 55%, from about 40% to about 50%, about 45%, about 46%, or about 47%.

In some embodiments, a visible light transmission (as defined by EN1836) of lens 200 is from about 30% to about 50%, from about 35% to about 45%, about 39%, about 40%, or about 41%.

In some embodiments, the lens 200 have an ultraviolet (UV) transmission cutoff at a wavelength from about 410 nm to about 440 nm or from about 420 nm to about 435 nm.

In some embodiments, an E313 yellowness index of the lens 200 is from about 5 to about 20, from about 7 to about 15, or from about 10 to about 14.

In some embodiments, a method for forming a filter configured to provide chroma enhancement for an eyewear is provided. This disclosure is not limited to this operational description. It is to be appreciated that additional operations may be performed. Moreover, not all operations may be needed to perform the disclosure provided herein. Further, some of the operations may be performed simultaneously, or in a different order than described. In some implementations, one or more other operations may be performed in addition to or in place of the presently described operations.

In some embodiments, a lens body with chroma enhancement is formed. In some embodiments, the process of forming the lens body can include providing an optically transparent material, and incorporating one or more wavelength filtering materials with the optically transparent material. Namely, the optically transparent material can be blended with the wavelength filtering materials to form the lens body. For example, one or more wavelength filtering dyes can be added to a molten resin before the resin is injected a mold cavity to form the lens body. By way of example and not limitation, the optically transparent material can include molten resin, polycarbonate (PC), allyl diglycol carbonate monomer (being sold under the brand name CR-39®), a resin layer (e.g., MR-8®), glass, nylon, polyurethane, polyethylene, polyureas, polyamide (PA), polyethylene terephthalate (PET), biaxially-oriented polyethylene terephthalate polyester film (BoPET, with one such polyester film sold under the brand name MYLAR®), acrylic (polymethyl methacrylate or PMMA), triacetate cellulose (TAC), a polymeric material, a co-polymer, a doped material, any other suitable material, or any combination thereof. By way of example and not limitation, the wavelength filtering materials and/or chroma enhancement material can include a dielectric stack, multilayer interference coatings, rare earth oxide additives, an organic dye, or a combination therefore. In some embodiments, the organic dye for the wavelength filtering material and chroma enhancement material can include ABS 473, ABS 574, or ABS 594 dye supplied by Exciton of Dayton, Ohio. In some embodiments, the process of forming the lens body can include forming a lens substrate, and forming a chroma enhancement filter over the lens substrate. By way of example and not limitation, a forming process of the lens substrate can include applying injection molding process, a thermoforming process, a casting process, or a machining process on the optically transparent material described above. By way of example and not limitation, the process of forming the chroma enhancement filter over the lens body can include placing the wavelength filtering material over one or more surfaces of the lens substrate using a deposition process, a coating process, an inkjet-printing process, an epitaxial process, a plating process, a material growth process (e.g., self-assembly growth), or a laminating process. In some embodiments, the process of forming the lens body can include forming a chroma enhancement filtering wafer, and forming a lens substrate over the a chroma enhancement filtering wafer. By way of example and not limitation, the process of forming a chroma enhancement filtering wafer can include injection molding or casting a wafer that includes one or more wavelength filtering materials. By way of example and not limitation, the process of forming the lens body over the wavelength chroma enhancement wafer can include placing the chroma enhancement filtering wafer in a mold cavity and molding an optically transparent material, such as resin, over one or more surfaces of the wavelength filtering wafer in the mold cavity. As a result, after the optically transparent material (e.g., resin) is cooled down and hardened, the lens body can conform to the wavelength filtering wafer. It is noted that the above described embodiments for forming the lens body are exemplary and not limiting. Various implementations for forming the lens body are described, for example, in U.S. patent application Ser. No. 15/359,317, which is incorporated by reference herein and is made part of this disclosure.

In some embodiments, one or more functional layers can be formed over the lens body. By way of example and not limitation, each of the one or more functional layers can include a hard coat layer, an interference stack, a flash mirror, a photochromic layer, an electrochromic layer, an anti-static coating, a liquid containing layer, a trichoic filter, a glass layers, a hybrid glass-plastic layer, an index matching layers, or any combination of these. In some embodiments, the process of forming the one or more functional layers can include a laminating technique, a coating technique, a deposition technique, or any combination of these.

It would be understood that the above noted embodiments are merely illustrative and not limiting. Other examples of forming the lens body having chroma enhancement filtering are disclosed in U.S. Pat. Pub. No. 2017/0075143, entitled “Eyewear and lenses with multiple molded lens components,” filed Nov. 22, 2016, and U.S. Pat. Pub. No. 2017/0102558, entitled “Eyewear with multiple functional layers,” filed Oct. 28, 2016, which are incorporated herein by reference.

In some embodiments, an optical reflectivity from the lens body is reduced. The reduction of the optical reflectivity can include forming an anti-reflection layer over the lens body's back surface and/or the lens body's front surface. In some embodiments, in response to the anti-reflection layer's refractive index being between air's refractive index (e.g., 1.0) and the lens body's refractive index, an optical reflectivity from the lens body's back surface can be reduced.

The foregoing disclosure outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A lens for an eyewear, comprising :
an optical filter, wherein a transmittance spectral profile of the optical filter comprises a saddleback transmission valley having a local maximum transmittance, a first minimum transmittance, and a second minimum transmittance, wherein:
the local maximum transmittance of the transmittance valley is positioned at a first wavelength from about 570 nm to about 600 nm; and
wherein a difference in transmittance between the first minimum transmittance and the local maximum transmittance is less than about 15%.

2. The lens of claim 1, wherein the transmittance spectral profile further comprises another transmittance valley, the other transmittance valley having a third minimum transmittance positioned at a second wavelength from about 465 nm to about 505 nm, wherein the minimum transmittance of the other transmittance valley is less than about 25%.

3. The lens of claim 1, wherein a spectral bandwidth of the second transmittance valley at the third minimum transmittance plus 2% is less than or equal to about 30 nm.

4. The lens of claim 3, wherein the spectral bandwidth of the second transmittance valley at the third minimum transmittance plus 20% is greater than or equal to about 40 nm.

5. The lens of claim 3, wherein the spectral bandwidth of the second transmittance valley at the third minimum transmittance plus 5% is less than or equal to about 40 nm.

6. The lens of claim 2, wherein the second wavelength is from about 470 nm to about 480 nm.

7. The lens of claim 6, wherein the second wavelength is about 477 nm.

8. The lens of claim 2, wherein the second wavelength is from about 485 nm to about 505 nm.

9. The lens of claim 8, wherein the second wavelength is about 500 nm.

10. The lens of claim 1, wherein the first minimum transmittance and the second minimum transmittance are greater than about 5%.

11. The lens of claim 10, wherein the first minimum transmittance and the second minimum transmittance are greater than about 5% and less than about 20%.

12. The lens of claim 11, wherein the first minimum transmittance and the second minimum transmittance are greater than about 5% and less than about 10%.

13. The lens of claim 1, wherein the local maximum transmittance is from about 5% to about 20%.

14. The lens of claim 1, wherein the local maximum transmittance is from about 10% to about 20%.

15. The lens of claim 1, wherein the local maximum transmittance is about 16%.

16. The lens of claim 1, wherein the local maximum transmittance is from about 5% to about 10%.

17. The lens of claim 1, wherein the optical filter comprises one or more organic dyes.

18. The lens of claim 1, wherein a scotopic transmission of the optical filter is less than about 40%.

19. The lens of claim 1, wherein an E313 yellowness index of the lens is less than about 20.

20. The lens claim 1, wherein a visible light transmission is from about 10% to about 50%.

21. The lens of claim 1, wherein a CIE chromaticity x value is from about 0.5 to about 0.7 and wherein a CIE chromaticity y value is from about 0.5 to about 0.7.

22. The lens of claim 1, wherein the first wavelength is from about 580 nm to about 590 nm.

23. The lens of claim 1, wherein the first wavelength is about 585 nm.

24. The lens of claim 1, wherein a difference between the first minimum and/or the second minimum transmittance and the local maximum transmittance is less than about 5%.

25. The lens of claim 1, wherein a difference between the first minimum transmittance and/or the second minimum transmittance and the local maximum transmittance is more than about 5%.

26. The lens of claim 1, wherein a spectral bandwidth of the saddleback transmittance valley at the local minimum transmittance plus 10% is less than or equal to about 40 nm.

27. The lens of claim 1, wherein a spectral bandwidth of the saddleback transmittance valley at the local minimum transmittance plus 25% of the local minimum transmittance is less than or equal to about 40 nm.

28. The lens of claim 1, wherein the saddleback transmittance valley is a transmittance valley between a first transmittance peak and a second transmittance peak, the first transmittance peak positioned at a third wavelength from about 520 nm to about 560 nm, the second transmittance peak positioned at a fourth wavelength from about 610 nm to about 650 nm.

29. The lens of claim 28, wherein a transmittance of the first transmittance peak is from about 10% to about 40% and a transmittance of the second transmittance peak is from about 20% to about 50%.

30. The lens of claim 29, wherein the transmittance of the first transmittance peak is from about 10% to about 20% and the transmittance of the second transmittance peak is from about 20% to about 30%.

31. The lens of claim 29, wherein the transmittance of the first transmittance peak is from about 30% to about 40% and the transmittance of the second transmittance peak is from about 40% to about 50%.

32. An eyewear including the lens of claim 1.

33.-49. (canceled)

50. An lens for an eyewear, wherein:
a visible light transmission of the lens is from about 10% to about 50%; and
a spectral profile of the lens comprises a saddleback absorbance peak in a spectral range of about 570 nm to about 600 nm, the saddleback absorbance peak having a local minimum absorbance located between a first maximum absorbance and a second maximum absorbance, wherein an optical density at the first maximum absorbance of the saddleback peak at a first wavelength is from about 0.5 to about 1.5 and an average transmittance in a spectral range of about 480 nm to about 530 nm is greater than about 5%.

51. The lens of claim 50, wherein the spectral profile further comprises another absorbance peak, the another absorbance peak having a maximum absorbance positioned at a second wavelength from about 465 nm to about 505 nm.

52. The lens of claim 51, wherein the second wavelength is from about 470 nm to about 480 nm.

53. The lens of claim 51, wherein the second wavelength is from about 485 nm to about 505 nm.

54. The lens of claim 50, wherein the local minimum absorbance is positioned at a third wavelength from about 580 nm to about 590 nm.

55. The lens of claim 54, wherein the third wavelength is about 585 nm.

56. The lens of claim 50, wherein the optical density at the first maximum absorbance of the saddleback peak at a first wavelength is from about 0.5 to about 1.

57. The lens of claim 50, wherein the optical density at the first maximum absorbance of the saddleback peak at a first wavelength is from about 1 to about 1.5.

58. The lens of claim 50, wherein the saddleback absorbance peak is an absorbance peak between a first absorbance minimum and a second absorbance minimum,
the first absorbance minimum positioned at a fourth wavelength from about 520 nm to about 560 nm, the second absorbance minimum positioned at a fifth wavelength from about 610 nm to about 650 nm.

59. The lens of claim 58, wherein the fourth wavelength is from about 520 nm to about 540 nm and the fifth wavelength is from about 620 nm to about 640 nm.

60. The lens of claim 50, wherein the visible light transmission is from about 10% to about 30%.

61. An eyewear including the lens of claim 50.

62.-70. (canceled)

71. A lens for an eyewear, comprising:
an optical filter, wherein a transmittance spectral profile of the optical filter comprises a saddleback transmission valley having a local maximum transmittance, a first minimum transmittance, and a second minimum transmittance, wherein:
the local maximum transmittance of the transmittance valley is positioned at a first wavelength from about 570 nm to about 600 nm; and
wherein a difference in transmittance between the first minimum transmittance and the local maximum transmittance is less than 2%.
